(19) United States
(12) Patent Application Publication
(10) Pub. No.: US 2002/0171681 A1
(43) Pub. Date: Nov. 21, 2002

(54) Image processing apparatus

(76) Inventors: Tatsuo Nomura, Souraku-gun (JP); Kohki Fukuda, Nara-shi (JP); Syoichiro Yoshiura, Ikoma-gun (JP)

Correspondence Address: DAVID G. CONLIN, ESQ., EDWARD & ANGELL, LLP, P.O. BOX 96169, BOSTON,, MA, 02209, US

(21) Appl. No.: 10/127,200

(22) Filed: Apr. 22, 2002

(30) Foreign Application Priority Data
May 21, 2001 (JP) 2001-151145

(51) Int. Cl. G09G 5/00

(52) U.S. Cl. 345/772

(57) ABSTRACT

If a paper jam has occurred during this copy reserving operation, a trouble icon appears on the LCD. This trouble icon relates to a problem that has occurred in a job other than the copy reservation job, but will be displayed on the copy reservation frame so as to warn the user. A controller displays the trouble icon at such a position that it does not affect other windows, keys and the like displayed on the LCD, for example, it does not obstruct the display, and nor is it laid over the display (it is displayed at a non-overlaid position). When this trouble icon is touched by the user, the controller displays a warning window displaying the content of the error, preferentially at the approximate center of the LCD (in the frontmost layer viewed from the user).

### BACKGROUND OF THE INVENTION

1. Field of the Invention

The present invention relates to an image processing apparatus wherein information as to a plurality of image processing functions such as copier, facsimile, printer, etc., is displayed on a display screen.

2. Description of the Related Art

Recently, printing machines (digital multi-functional machines) which have a plurality of functions(mode) such as copier, facsimile, printer, etc., and can implement multiple functions, by a single machine have been developed. Such digital multi-functional machines usually have a control panel that includes a display screen for displaying the user guidance of the operational statuses of individual modes and an input device for receiving user instructions.

In the control panel built into recent digital multi-functional machines, a dot-matrix type liquid crystal display(LCD) is often employed for display purposes in order to display as many pieces of information as necessary. There have also been developed control and instruction devices (transparent touch screens) which allow instructions to be input to the machine based on various pieces of information being displayed on the LCD.

Further, in such control panels, various pieces of advice information (guidance information) are adapted to be displayed on the LCD in order for user to easily understand the operational status of the digital multi-functional machine. Such advise information, though its display form varies depending on the display capacity and size of the display screen, is basically displayed as a window format in part of the display screen when the display screen is large in size. With a small-sized display screen, the information is often displayed using almost whole part of the display screen.

Incidentally, recent digital multi-functional machines have become more complicated in their mechanisms and functions due to increase in the number of mode types. Therefore, many pieces of information should be displayed on the display screen of the control panel, which can cause a reduction in user operativity.

For example, in a digital multi-functional machine which is able to implement scanner, printer and communication functions simultaneously, while a printing job designated by a user (first user) is being implemented in the printer, another user (second user) may operate the control panel to give instructions of a reservation of a new job(printing or transmission) of image information having been input through the scanner.

If an error occurs in the printer during this, a window(error frame) for notifying the error is displayed on the whole area of the display or in the guidance display area (the display area in which information unrelated with the user's instructions is shown).

For example, in the facsimile machine disclosed in Japanese Patent No.3031793, if an error has occurred while it is being operated, the advise information showing the occurrence of the error is adapted to be displayed in the window representation at the center of the display screen. Japanese Patent Application Laid-Open Hei 8 No.235080 discloses a configuration in which when an error has occurred, the upper part of the display screen is used as the error display frame.

That is, in such a case, warning of an error as to the first user's imaging is given to the second user, so that the second user gets confused and is interrupted to implement a reservation task. Further, since the second user has no knowledge about the content of the job having caused the error, it is impossible to resolve the error. Moreover, if the system is configured so that the error message display will continue until the error is resolved, there may be cases where other information which should be displayed more preferentially cannot be displayed, resultantly degrading the user operativity, greatly.

### SUMMARY OF THE INVENTION

The present invention has been devised in order to solve the above conventional problems, and it is therefore an object of the present invention to provide an image processing apparatus which is able to definitely inform the user of necessary information without causing any adverse effect on other command control.

An image processing apparatus of the present invention for implementing a plurality of processing functions relating to imaging designated by a user, includes: an input portion through which a user inputs an instruction of a processing job relating to the processing functions; functional units for implementing a plurality types of processing functions relating to imaging; a display portion for displaying information as to each processing function; and a controller for controlling the units, and is characterized in that the controller generates a job information window displaying job information on the display portion and displays the job information window on the display portion, and if there is warning information to be informed to the user in processing jobs, the controller displays a warning icon representing the warning information, at such a position in the job information window that the icon will not affect the display of the job information.

The invention is also characterized in that in accordance with the indication from the user through the input portion, the controller switches the display of the warning icon into a warning window displaying the warning information, in such a manner that the warning window is laid over the job information window.

An image processing apparatus of the present invention for implementing a plurality of processing functions relating to imaging designated by a user, includes: an input portion through which a user inputs an instruction of a processing job relating to the processing functions; functional units for implementing a plurality types of processing functions relating to imaging; a display portion for displaying information as to each processing function; and a controller for controlling the units, and is characterized in that the controller generates a job information window displaying job information on the display portion and displays the job information window on the display portion, and if there is warning information to be informed to the user in processing jobs, the controller displays a warning window displaying the warning information so as to be laid over the job information window.

The invention is characterized in that in accordance with the indication from the user through the input portion the controller switches the display of the warning window into a warning icon representing the warning information, at such a position in the job information window that the icon will not affect the display of the job information.

An image processing apparatus of the present invention for implementing a plurality of processing functions relating to imaging designated by a user, includes: an input portion through which a user inputs an instruction of a processing job relating to the processing functions; functional units for implementing a plurality types of processing functions relating to imaging; a display portion for displaying information as to each processing function; and a controller for controlling the units, and is characterized in that the controller generates on the display portion a plurality of job information windows for displaying job information in accordance with processing jobs carried out by the functional units and displays the job information windows in an overlaid and shifted manner so that part of the job information windows is exposed to be seen, and if there is warning information to be informed to the user, the controller displays a warning icon representing the warning information, at such a position in the exposed display portion of a job information window in a lower layer that the icon will not affect the display of the job information.

The invention is characterized in that in accordance with the indication from the user through the input portion the controller switches the display of the warning icon into a warning window displaying the warning information, in such a manner that the warning window is laid over the job information window.

An image processing apparatus of the present invention for implementing a plurality of processing functions relating to imaging designated by a user, includes: an input portion through which a user inputs an instruction of a processing job relating to the processing functions; functional units for implementing a plurality types of processing functions relating to imaging; a display portion for displaying information as to each processing function; and a controller for controlling the units, and is characterized in that the controller generates on the display portion a plurality of job information windows for displaying job information in accordance with processing jobs carried out by the functional units and displays the job information windows in an overlaid and shifted manner so that part of the job information window is exposed to be seen, and if there is warning information to be informed to the user, the controller displays a warning window displaying the warning information so as to be laid over the job information window.

The invention is characterized in that in accordance with the indication from the user through the input portion the controller switches the display of the warning window into a warning icon representing the warning information, displayed at such a position in the exposed display portion of the job information window relating to the warning information that the icon will not affect the display of the job information.

An image processing apparatus of the present invention for implementing a plurality of processing functions relating to imaging designated by a user, includes: an input portion through which a user inputs an instruction of a processing job relating to the processing functions; functional units for implementing a plurality types of processing functions relating to imaging; a display portion for displaying information as to each processing function; and a controller for controlling the units, and is characterized in that the controller generates one job information window for displaying job information for each processing job carried out by the functional units and displays the job information window on the display portion, and when there is warning information to be informed to the user relating to the processing jobs and if the warning information relates to the job content in the job information window, the controller displays the warning window displaying the warning information so as to be laid over the job information window; and if the warning information does not relate to the job content in the job information window, the controller displays a warning icon representing the warning information at such a position in the job information window that the icon will not affect the display of the job information.

An image processing apparatus of the present invention for implementing a plurality of processing functions relating to imaging designated by a user, includes: an input portion through which a user inputs an instruction of a processing job relating to the processing functions; functional units for implementing a plurality types of processing functions relating to imaging; a display portion for displaying information as to each processing function; and a controller for controlling the units, and is characterized in that the controller generates one job information window for displaying job information for each type of processing jobs carried out by the functional units and displays the job information windows in an overlaid and shifted manner so that part of the job information windows in the lower layers is exposed to be seen, and when any of the processing functions has warning information to be informed to the user and if the warning information relates to the job content of the job information window being displayed in the frontmost layer, the controller displays the warning window displaying the warning information so as to be laid over the job information window; if the warning information does not relate to the job content of the job information window being displayed in the frontmost layer, the controller displays a warning icon representing the warning information at such a position in the exposed display portion of the job information windows that the icon will not affect the display of the job information.

The invention is also characterized in that when a new processing job is entered, the controller displays the warning window displaying the warning information so as to be laid over the job information window when the new processing job relates to the warning information; and the controller displays the warning icon representing the warning information at such a position in the job information window that the icon will not affect the display of the job information when the job does not relate to the job content of the job information window.

The warning window is preferably displayed at the approximate center of the display portion. The job information window displayed in the front layer of the display portion may be that displaying information relating to the job for which the user inputs instructions through the input portion, and the warning information may be trouble information as to a functional unit.

In the present invention, the controller displays warning information in window or icon representation. The user is able to switch the display form of the warning information as appropriate. In the case of icon representation, it is possible to indicate to the user the fact that there is error information to be displayed without hiding the necessary display areas for the operation. In the case of window form, it is possible to given the detailed content of the warning information to the user.

When a user makes an entry of control and instruction through the input portion, the controller may determine the display form by judging whether the command control frame(job information window) relates to the warning information. This configuration does not trouble the user to select the display form, thus making it possible to improve the operativity. When the operation is advanced further, the controller progressively determines the display form by judging the correlation of the warning information to the command control frame.

### BRIEF DESCRIPTION OF THE DRAWINGS

FIG. 1 is a block diagram showing one embodiment of a digital multi-functional machine as an image processing apparatus according to the present invention.

FIG. 2 is an overall view showing a control panel of a digital multi-functional machine.

FIGS. 3A to 3C are illustrative views of example 1, showing the guidance display when paper jamming has occurred while a copy reservation is being made.

FIGS. 4A to 4C are illustrative views of examples 2 and 10, showing the guidance display when paper jamming has occurred during a facsimile transmission.

FIG. 5 is a flowchart of the guidance display operational sequence, by a controller 19, for displaying a warning icon before displaying a warning window.

FIGS. 6A to 6C are illustrative views of examples 3 and 9, showing the guidance display when paper jamming has occurred while a copy reservation is being made.

FIGS. 7A to 7C are illustrative views of example 4, showing the guidance display when paper jamming has occurred during a facsimile transmission.

FIG. 8 is a flowchart of the guidance display operational sequence, by a controller 19, for displaying a warning window before displaying a warning icon.

FIGS. 9A to 9C are illustrative views of example 5, showing the guidance display when paper jamming has occurred while a copy reservation is being made.

FIGS. 10A to 10C are illustrative views of examples 6 and 12, showing the guidance display when paper jamming has occurred during a facsimile transmission.

FIGS. 11A to 11C are illustrative views of examples 7 and 11, showing the guidance display when paper jamming has occurred in the printer unit while a copy reservation is being made.

FIGS. 12A to 12C are illustrative views of example 8, showing the guidance display when paper jamming has occurred during a facsimile transmission.

FIG. 13 is a flowchart of the display processing sequence by a controller in the third embodiment.

FIG. 14 is a flowchart of the display processing sequence by a controller, following that shown in FIG. 13 in the third embodiment.

FIGS. 15A to 15D are illustrative views of example 13, showing the guidance display when entry of a new copy reservation starts in a state where paper has run out in the printer unit.

FIG. 16 is a flowchart of the display processing sequence by a controller in example 13.

FIGS. 17A to 17D are illustrative views of example 13, showing the guidance display when entry of a new copy reservation starts in a state where paper has run out in the printer unit.

FIG. 18 is a flowchart of the display processing sequence by a controller in example 14.

FIGS. 19A to 19D are illustrative views of example 14, showing the guidance display when entry of a new copy reservation starts in a state where staples have run out in the printer unit.

FIG. 20 is a flowchart of the display processing sequence by a controller in example 15.

FIGS. 21A to 21D are illustrative views of example 16, showing the guidance display when entry of a new transmission job reservation starts in a state where paper has run out in the printer unit.

FIG. 22 is a flowchart of the display processing sequence by a controller in example 16.

### DESCRIPTION OF THE PREFERRED EMBODIMENTS

The embodiments of the present invention will be described with reference to the drawings.

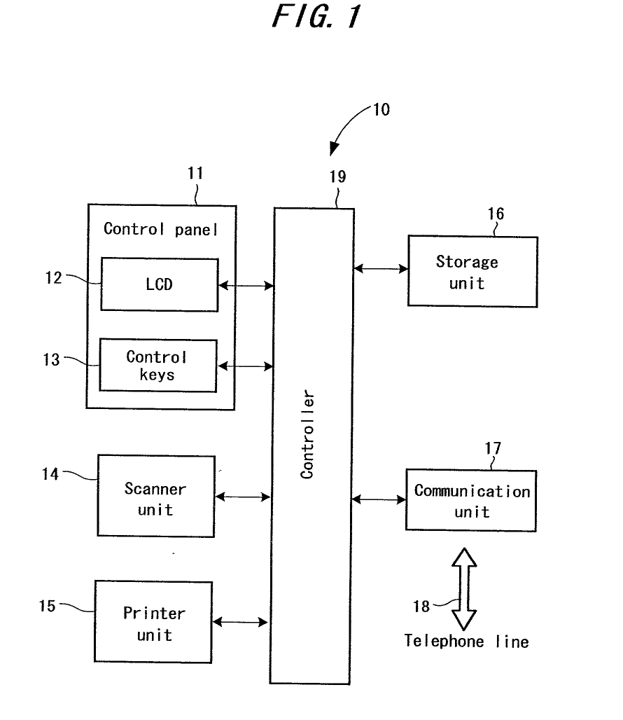

FIG. 1 is a block diagram showing one embodiment of a digital multi-functional machine as an image processing apparatus according to the present invention.

A digital multi-functional machine 10 according to the present embodiment has the functions of copier, scanner, printer and facsimile machine, and includes a control panel 11, scanner unit 14, printer unit 15, storage unit 16, communication unit 17 and controller 19.

In this multi-functional machine 10, controller 19 controls diverse units so as to perform parallel operations in the mode (copier mode) of printing the images read through scanner unit 14 by printer unit 15, in the mode (printer mode) of printing image data input externally through communication unit 17 by printer unit 15, in the mode (image transmission mode) of transmitting the images scanned by scanner unit 14 externally via communication unit 17 and telephone line 18, and in the mode(image receiving mode) of printing the image data input via communication unit 17 and telephone line 18 by printer unit 15.

Control panel 11 includes a display screen (LCD 12) for displaying guidance of the operational statuses of individual modes to the user and an input device (control keys 13) for receiving user's instructions. The image data scanned by scanner unit 14, the image data exchanged through communication unit 17, the display data to be displayed on LCD 12, and the like are once stored in storage unit 16 as indicated by controller 19 and read out by controller 19 and subjected to the associated processes.

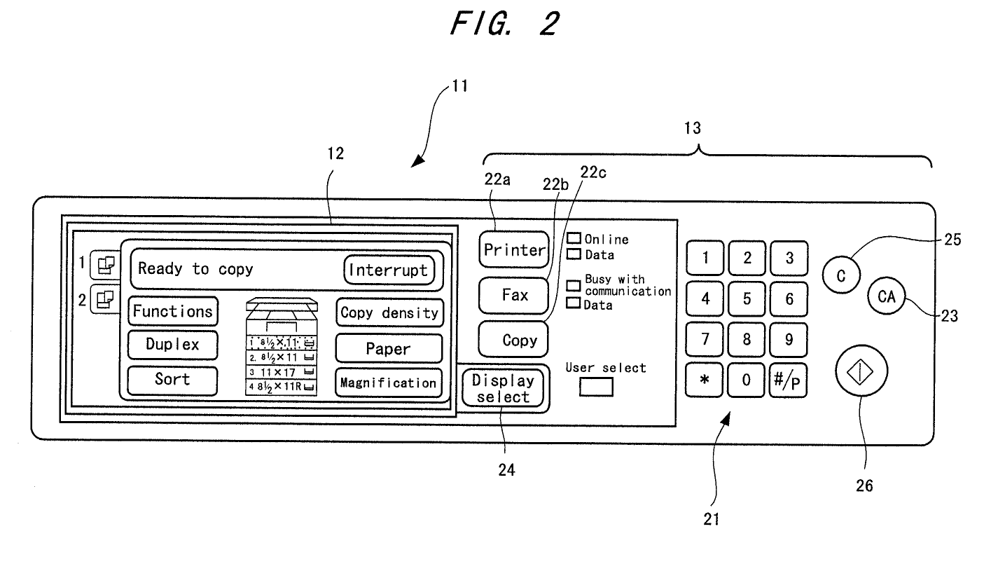

FIG. 2 is an overall view showing this control panel 11. As shown in this figure, control panel 11 has LCD 12 on its left half and control keys 13 on its right half.

LCD 12 is a touch-panel LCD (an LCD having a transparent touch screen) capable of graphic display and includes a transparent touch screen (touch keys) which allows for designation of various conditions and selection of desired display content, based on the information displayed on the display in a flip-through manner.

For example, LCD 12 shown in FIG. 2 presents the display for copy reservation, including a duplex key for selecting either duplex printing or one-sided printing, a sort key for instructing the sorting of sheets to be output, a copy density key for designating the copy density level, a paper select key for selection of a type of sheet (of recording paper), a magnification key for setting the copy magnification, a functional key for designating the detail of other functions. When pressing the touch keys directly with the finger, the user is able to set or select various conditions.

A numeric keyboard 21 of control keys 13 includes keys for numeric input (such as number of copies to be made). A start key 26 is that for commanding the start of a copying operation. A clear key 25 is that for clearing the settings of copy conditions displayed on LCD 12 or stopping the copying operation. A clear-all key 23 is that for resetting the settings of copying conditions to default values.

Printer, fax and copy keys 22a, 22b and 22c are keys for mode selection and each are adapted to become illuminated when the mode selection key is selected so that the selected mode can be known. A frame select key 24 is to switch the display in advance into the window of a desired mode selected from the windows of various modes displayed on LCD 12.

Next, the embodiments of the display on LCD 12 as the display portion of the digital multi-functional machine will be described in detail. In each of the first to fourth embodiments to be described hereinbelow, description will be made of the display forms of cases where a trouble has occurred during a certain process when a plurality of processes are being effected in digital multi-functional machine 10.

### The First Embodiment

The first embodiment is configured so that one window for representing the content of a job is displayed on the full frame of LCD 12 and the display form can be changed by the user when trouble information needs to be displayed. Examples 1 to 4 are the specific examples.

### EXAMPLE 1

Example 1 shows a case where a paper jam (sheet jam) error (trouble) has occurred while a copy reserving operation is being performed in digital multi-functional machine 10 and how the fact is displayed on LCD 12.

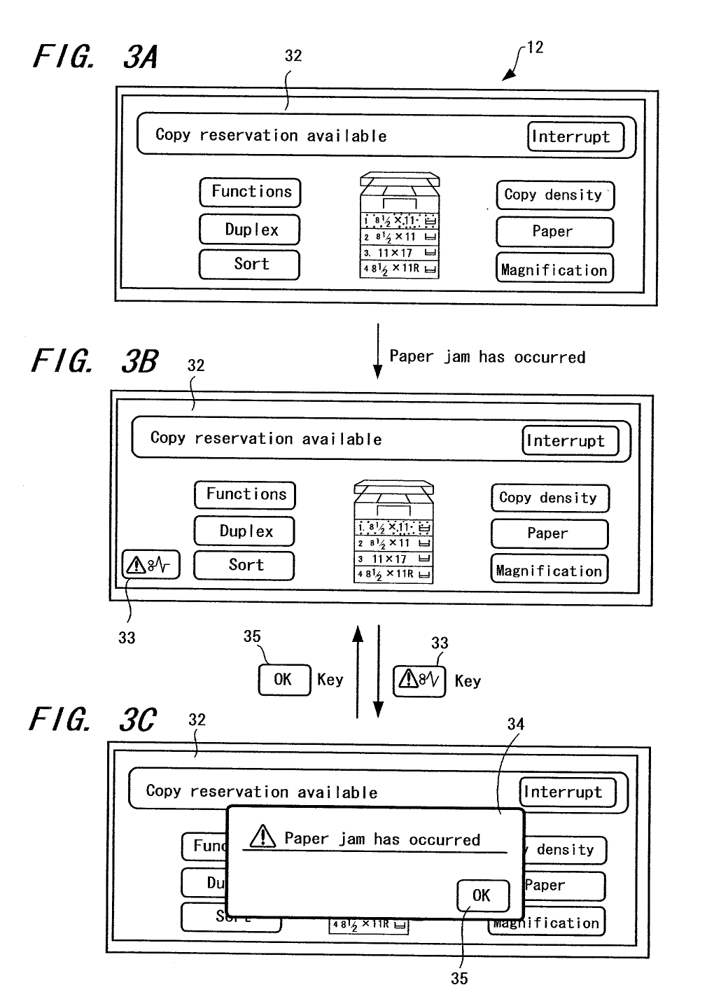

FIGS. 3A to 3C are illustrative views of example 1, showing the guidance display when an error (paper jamming) has occurred during a copy reserving operation.

As shown in FIG. 3A, when a user makes a copy reservation in this multi-functional machine 10 (FIG. 1), a copy reservation frame 32 is fully displayed (using substantially the full frame of the display) on LCD 12. Copy reservation frame 32 is a job information window that displays the information for a copy reservation task.

If a paper jam has occurred during this copy reserving operation, a trouble icon (warning icon) 33 appears on LCD 12, as shown in FIG. 3B. This trouble icon 33 relates to a trouble that has occurred in a job other than the copy reservation task, but will be displayed on copy reservation frame 32 so as to warn the user. As shown in this figure, controller 19 displays the trouble icon 33 at bottom left on LCD 12, at such a position that it does not affect the job information display including other windows, job information, keys and the like displayed on LCD 12, for example, it does not obstruct the display of job information, and nor is it laid over the display of job information (it is displayed at a non-overlaid position).

When this trouble icon 33 is touched by a user, controller 19 displays a warning window 34 informing the content of the error, preferentially at the approximate center of LCD 12 (in the frontmost layer viewed from the user).

Here, to describe the positional relationships when a plurality of windows are displayed in layers, a layer displayed on the front side of LCD 12 is referred to as an upper layer and a layer displayed in the interior side of LCD 12 is referred to as a lower layer. Accordingly, a window displayed across the full frame (substantially full frame) should be called an upper layer window whereas a window partly or substantially totally hidden by the upper layer window should be called a lower layer window. Therefore, the third window from the top may be partly or totally hidden by two upper windows.

### EXAMPLE 2

Example 2 shows a case where a paper jam (sheet jam) error (trouble) has occurred while a user is performing a facsimile transmitting operation in digital multi-functional machine 10 (FIG. 1) and how the fact is displayed on LCD 12.

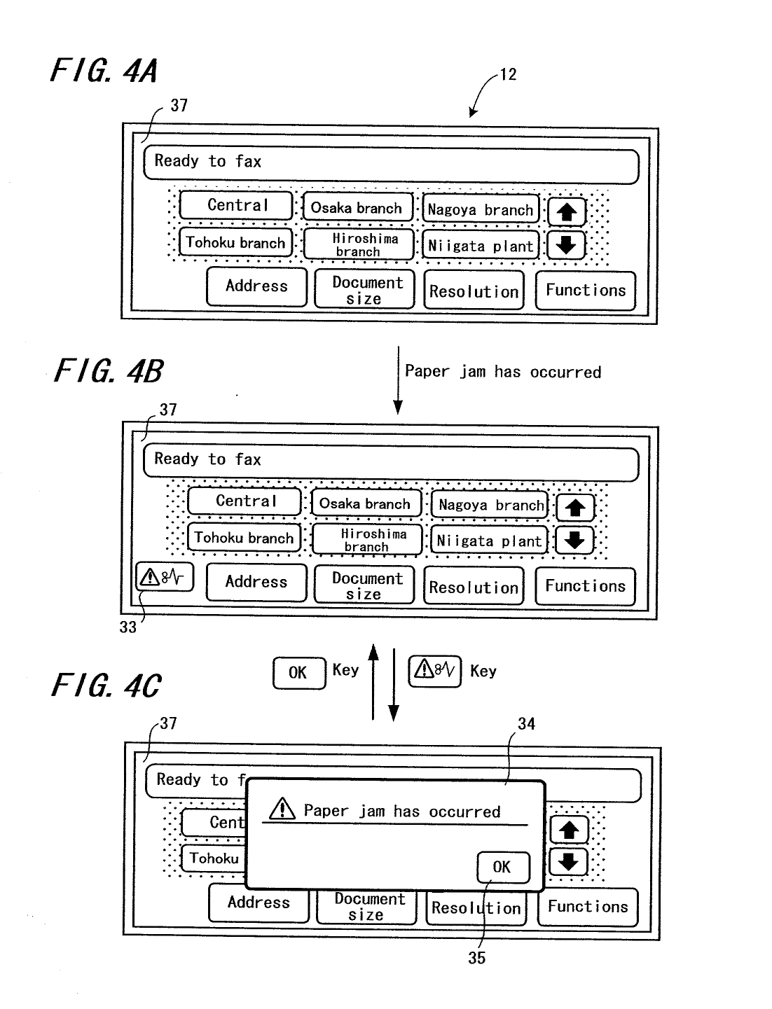

FIGS. 4A to 4C are illustrative views of example 2, showing the guidance display when paper jamming has occurred during a facsimile transmission.

As shown in FIG. 4A, when a user performs a facsimile transmission in this multi-functional machine 10, a facsimile transmission reservation frame 37 is fully displayed (using substantially the full frame) on LCD 12. This facsimile transmission frame 37 is a job information window that displays the information for a facsimile transmission job.

If a paper jam has occurred during this facsimile transmission, the same trouble icon 33 as above appears at the bottom left on LCD 12, as shown in FIG. 4B. This trouble icon 33 relates to a trouble that has occurred in a job other than the facsimile transmission, but will be displayed on facsimile transmission frame 37 so as to warn the user.

When this trouble icon 33 is touched by a user, a warning window 34 informing the content of the error is displayed preferentially at the approximate center of LCD 12 (in the frontmost layer viewed from the user), as shown in FIG. 4C. When ‘OK’ key 35 in this warning window 34 is touched, the display is adapted to return to that shown in FIG. 4B.

Next, the operation of the guidance display process by controller 19 in examples 1 and 2 will be described.

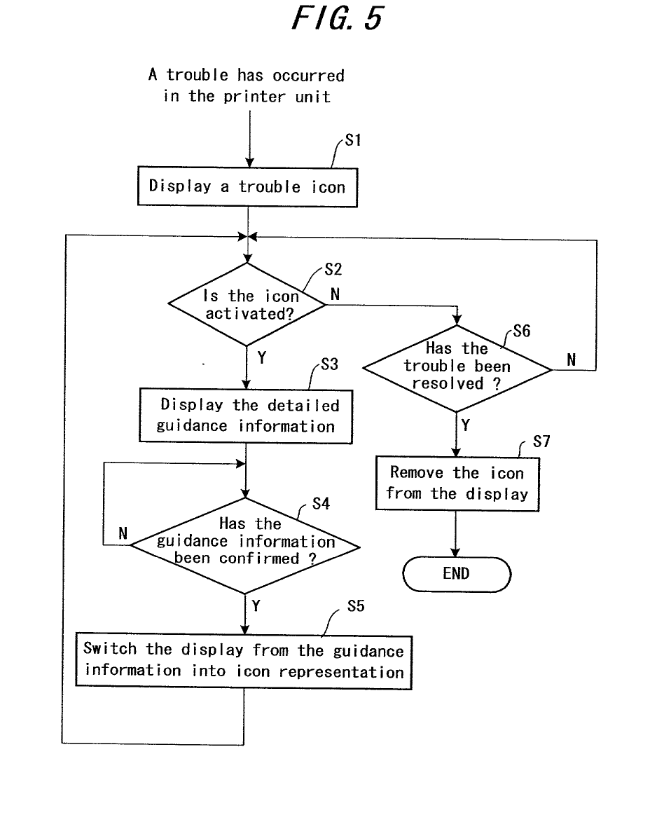

FIG. 5 is a flowchart of the guidance display operational sequence, by controller 19 (FIG. 1), for displaying a warning icon before displaying a warning window.

When an error (trouble) has occurred in printer unit 15 (FIG. 1), controller 19 displays trouble icon 33 at such a position that it does not affect the job information display including job information, keys and the like, in reservation frame 32 (FIG. 3) or 37 (FIG. 4) on LCD 12 as stated above, for example, it does not obstruct the display or it is positioned at a non-overlaid position (S1). When trouble icon 33 is touched by a user (S2), controller 19 displays warning window 34 of the detailed guidance information in the frontmost layer at the approximate center of LCD 12 (S3). When the user confirms the guidance information and touches ‘OK’ key 35 in this window (S4), the display of warning window 34 is adapted to return to the trouble icon 33 representation (S5).

When trouble icon 33 is not touched by the user (S2), controller 19 checks whether the trouble has been resolved by the user (S6). If the trouble has been resolved, controller 19 removes trouble icon 33 from LCD 12 (S7) and completes the operation. If the trouble has not been resolved, the operation returns to S12, where it is checked whether ‘OK’ key 35 has been touched.

As described above, in examples 1 and 2, if a trouble has occurred in printer unit 15 during making a reservation, icon 33 informing that the trouble has occurred is displayed at such a position on LCD 12 that it does not affect either the windows as job information display or control key display, for example, it does not obstruct the display, and nor is it laid over the display. When this icon 33 is touched, the specific content of the trouble is adapted to be displayed by warning window 34.

In the above way, it is possible to inform the user that there is a piece of error information to be displayed, without hiding the frame needed for operational control, hence it is possible to warn of the occurrence of a trouble without disturbing the user's operational control.

Further, the error information (detailed guidance information) can be displayed by warning window 34 at the timing desired by the user, so that the user is able to check the details when necessary.

### EXAMPLE 3

In example 1, trouble icon 33 appears first when an error has occurred in printer unit 15 while scanner unit 14 is being operated, and when the icon 33 is touched, the content of the error is displayed by warning window 34. However, the embodiment should not be limited to this, so that it is possible that the content of the error is displayed first in warning window 34 and thereafter icon 33 is displayed.

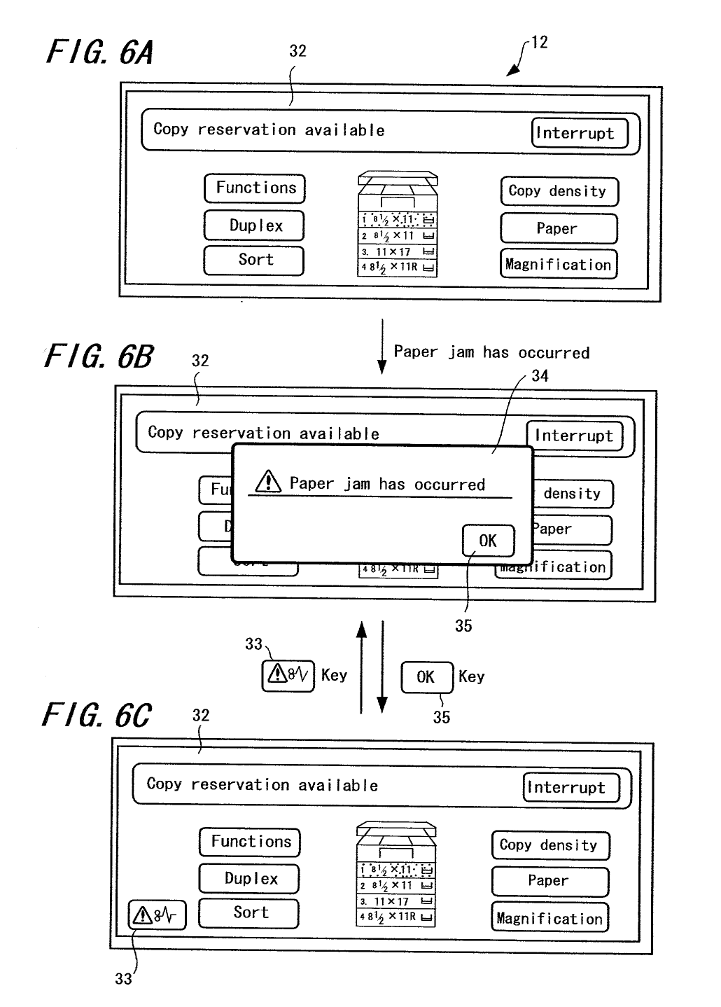

FIGS. 6A to 6C are illustrative views of example 3, showing the guidance display when an error (paper jamming) has occurred during a copy reserving operation.

In this case, as in example 1, when a user makes a copy reservation, copy reservation frame 32 is fully displayed (using substantially the full frame of the display) on LCD 12, as shown in FIG. 6A. If a paper jam has occurred during this copy reserving operation, warning window 34 indicating the content of the error is displayed preferentially at the approximate center of LCD 12 (in the frontmost position of the user), as shown in FIG. 6B. When ‘OK’ key 35 in this warning window 34 is touched, trouble icon 33 appears at the bottom left, as shown in FIG. 6C.

### EXAMPLE 4

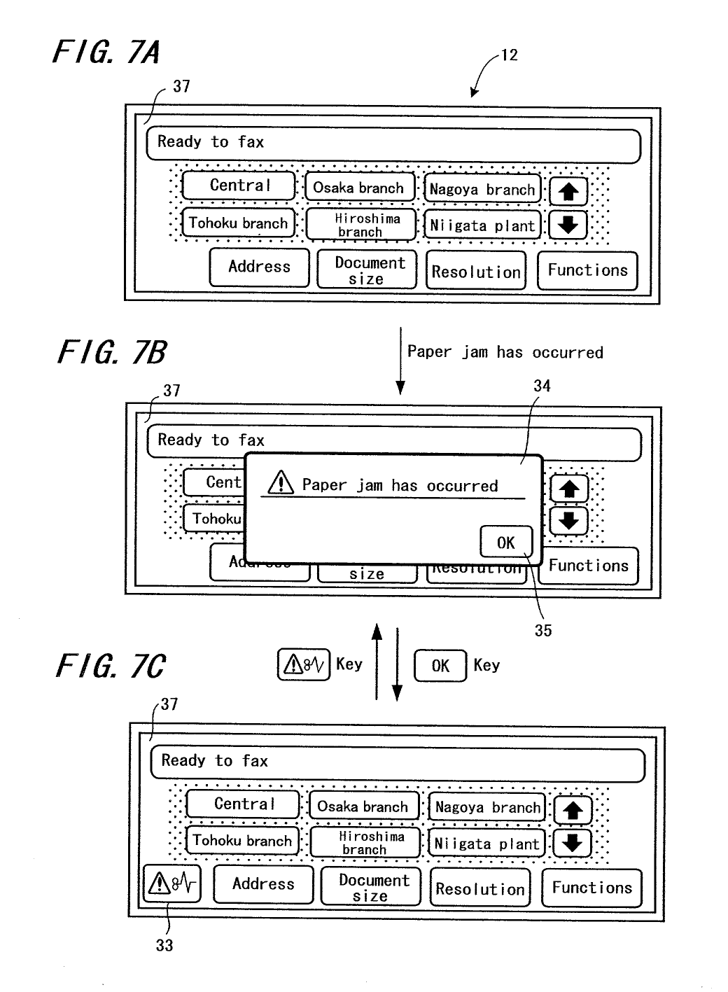

Also in example 4, the content of the error is displayed similarly to example 3, in warning window 34, thereafter icon 33 is displayed. FIGS. 7A to 7C are illustrative views of the example 4, showing the guidance display when paper jamming has occurred during a facsimile transmission.

As shown in FIG. 7A, a facsimile transmission frame 37 is fully displayed (using substantially the full frame) on LCD 12. If a paper jam occurs in this state, warning window 34 indicating the content of the error is displayed at the center of LCD 12, as shown in FIG. 7B. When ‘OK’ key 35 in this warning window is touched, trouble icon 33 appears at the bottom left, as shown in FIG. 7C.

Next, the operation of the guidance display process by controller 19 in examples 3 and 4 will be described.

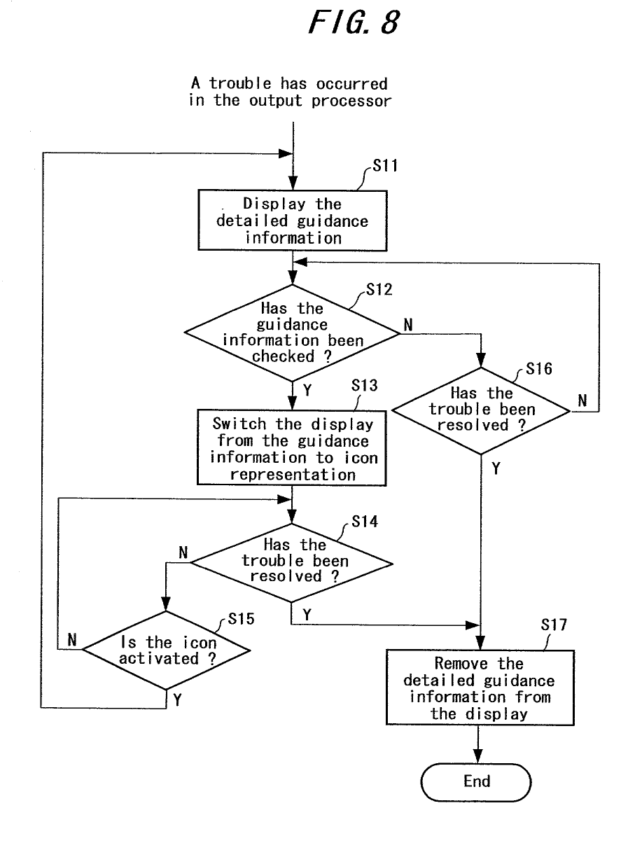

FIG. 8 is a flowchart of the guidance display operational sequence, by controller 19, for displaying a warning window before displaying an icon.

As shown in the figure, when an error (problem) has occurred in printer unit 15, controller 19 displays the detailed guidance display by warning window 34 in the frontmost layer at the approximate center of reservation frame 32 or 37 of LCD 12 (S11). When ‘OK’ key 35 is touched by the user (S12), controller 19 displays icon 33 at the bottom left of LCD 12 (S13). At this point, when the user touches this icon 33 (S15) with the problem unsolved (S14), the operation goes back to S11, where the detailed guidance information is displayed by warning display 34.

On the other hand, after S12 or S13, when it is confirmed that the trouble has been resolved by the user (S14, S16), controller 19 removes trouble icon 33 from LCD 12 (S17) and completes the operation.

In this way, the warning window showing the detailed guidance information is displayed in the frontmost layer as soon as an error occurs, so that the user can obtain detailed information and take the necessary action. If the trouble is not one the user needs to resolve immediately, the user may change it into its warning icon so that it is not laid over other display information. Thus, the user is prevented from being disturbed by the display when engaging in their current job while other users can also be warned.

### The Second Embodiment

The second embodiment is configured so that a plurality of windows each representing the content of a job are displayed in an overlaid and shifted manner and the display form of the warning information is adapted to be switched by the user. Examples 5 to 8 are the specific examples.

### EXAMPLE 5

Example 5 shows a case where a paper jam (sheet jam) error (trouble) has occurred while a user is making a copy reservation in digital multi-functional machine 10 and how the fact is displayed on LCD 12.

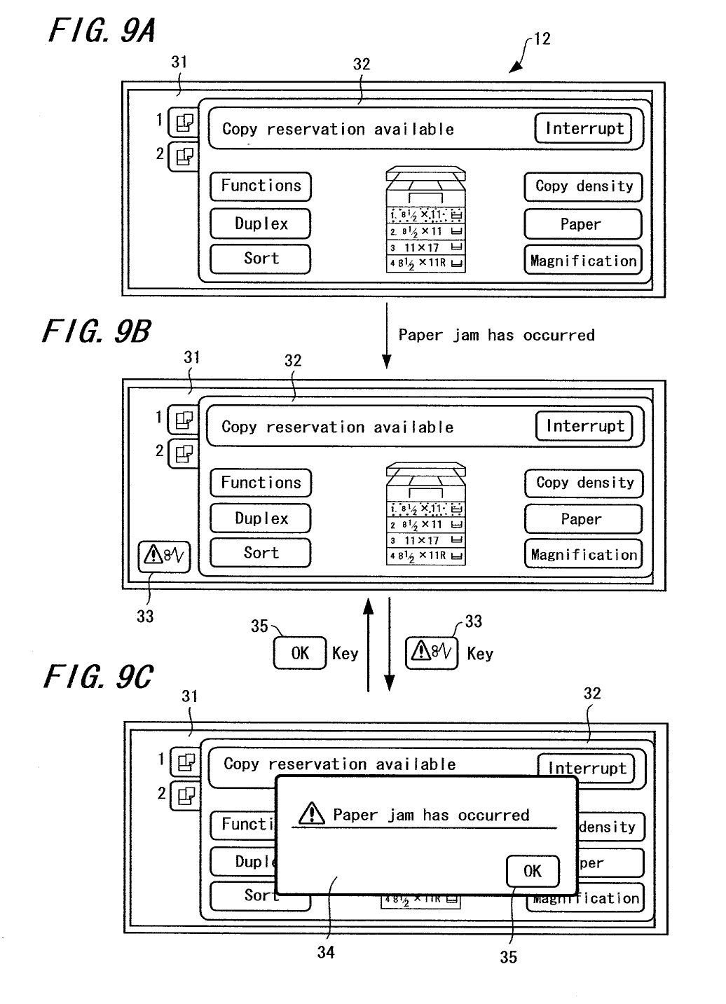

FIGS. 9A to 9C are illustrative views of example 5, showing the guidance display when an error (paper jamming) has occurred during a copy reserving operation.

As shown in FIG. 9A, when a user makes a copy reservation in this multi-functional machine 10, copy reservation frame 32 has been displayed on LCD 12, preferentially over a print status frame 31. More specifically, copy reservation frame 32 is laid over, and shifted with respect to, print status frame 31 with part of print status frame 31 exposed to be seen. The first and second print job icons are displayed at the upper left in the exposed area, so as to indicate that print jobs have been reserved already. In this display status, if paper jamming occurs in printer unit 15, trouble icon 33 is displayed at the bottom left in the exposed area of printer status frame 31 on LCD 12, as shown in FIG. 9B, to warn the user.

As shown in this figure, trouble icon 33 is displayed at the bottom left of print status frame 31 displayed on LCD 12 at such a position that it does not affect the job information display including other display information, keys and the like displayed on LCD 12, for example, it does not obstruct the job information display, and nor is it laid over the job information display (is displayed at a non-overlaid position).

When this trouble icon 33 is touched by a user, controller 19 (FIG. 1) displays a warning window 34 informing the information (detailed guidance information) indicating the content of the trouble, preferentially (in the front layer viewed from the user) over copy reservation frame 32 displayed on LCD 12, as shown in FIG. 9C.

This detailed guidance information is stored in storage unit 16 (FIG. 1) in correspondence with icon 33, and when icon 33 is touched, controller 19 displays warning window 34.

### EXAMPLE 6

Example 6 shows a case where a paper jam (sheet jam) error (trouble) has occurred while a user is performing a facsimile transmitting operation in digital multi-functional machine 10 and how the fact is displayed on LCD 12.

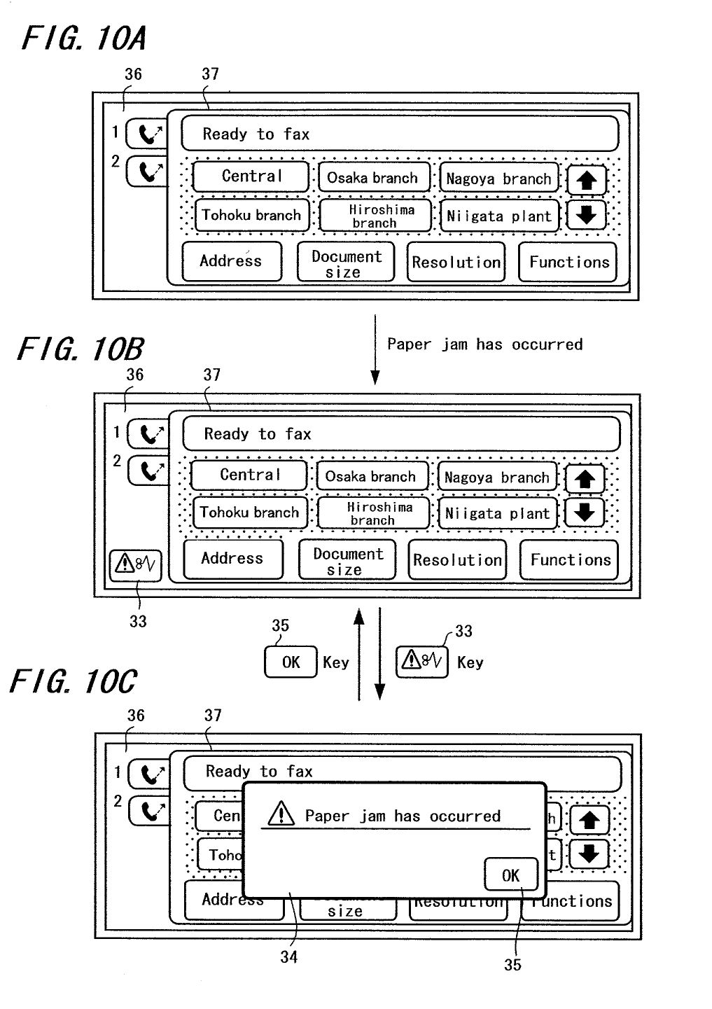

FIGS. 10A to 10C are illustrative views of example 6, showing the guidance display when paper jamming has occurred during a facsimile transmission.

As shown in FIG. 10A, in this multi-functional machine 10, a facsimile transmission status frame 36 and facsimile transmission reservation frame 37 are displayed on LCD 12. The facsimile transmission reservation frame 37 is displayed preferentially (in the front position) over facsimile transmission status frame 36. More specifically, facsimile transmission reservation frame 37 is laid over, and shifted with respect to, facsimile transmission status frame 36 with part of facsimile transmission status frame 36 exposed to be seen. The first and second transmission job icons are displayed at the upper left in the exposed area, so as to indicate that facsimile transmission jobs have been reserved already. In this display status, if paper jamming occurs in printer unit 15 (FIG. 1), trouble icon 33 is displayed in the same manner as above in the exposed area of facsimile transmission status frame 36 on LCD 12, as shown in FIG. 10B. When this trouble icon 33 is touched, warning window 34 informing the content of the error is displayed as shown in FIG. 10C. When ‘OK’ key 35 in this window 34 is touched, the display is adapted to return to that shown in FIG. 10B.

Next, the operation of the guidance display process by controller 19 in examples 5 and 6 will be described with reference to FIG. 5.

As shown in the figure, when an error (trouble) has occurred in printer unit 15, controller 19 displays trouble icon 33 at the predetermined position in status frame 31 or 36 on LCD 12 (S1).

Then, when trouble icon 33 is touched by a user (S2), controller 19 displays warning window 34 of the detailed guidance information in the frontmost layer at the approximate center of LCD 12 (S3). When the user touches ‘OK’ key 35 in this window (S4), the display is adapted to return to the icon representation (S5).

When trouble icon 33 is not touched (S2), controller 19 checks whether the trouble has been resolved by the user at S6. If the check is affirmative, controller 19 removes trouble icon 33 from LCD 12 (S7) and completes the operation.

As described above, in this multi-functional machine, if a trouble occurs in printer unit 15 while scanner unit 14 is being used in the copy reservation mode or facsimile transmission reservation mode, the icon warning of the occurrence of the trouble is displayed on LCD 12 at such a position that it does not affect the display (windows and keys) on the command control frame through which a new reservation is being made, not disturbing the display or being laid over the display, for example. When this icon is touched, the detailed content of the trouble is adapted to be displayed in window representation.

In the above way, it is possible to inform the user that there is a piece of error information to be displayed, without hiding the frame of display needed for the command control in the reservation mode, hence it is possible to warn of the occurrence of a problem without disturbing the user's command control.

Further, the error information (detailed guidance information) can be displayed at the timing desired by the user, so that the user is able to check the details when necessary.

### EXAMPLE 7

In example 5, icon 33 is displayed first when an error has occurred in printer unit 15 while scanner unit 14 is being operated in the copy reservation mode or facsimile transmission reservation mode, and when the icon is touched, the content of the error is adapted to be displayed by warning window 34. However, the embodiment should not be limited to this, so that it is possible that the content of the error is displayed first in warning window 34 and thereafter icon 33 is displayed.

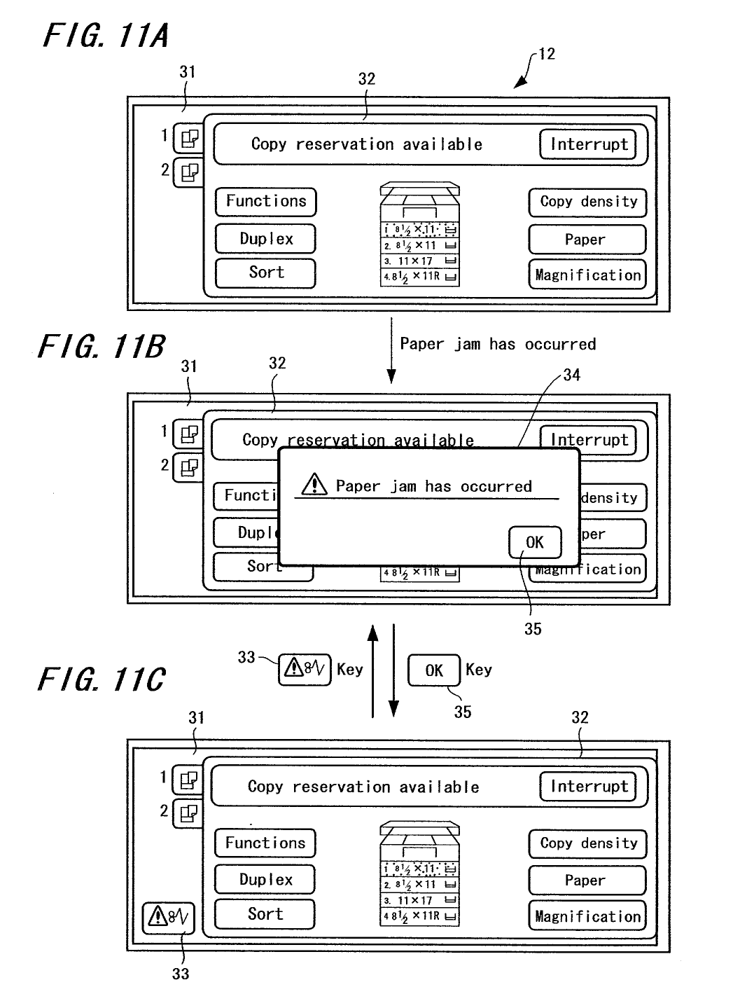

FIGS. 11A to 11C are illustrative views of example 7, showing the guidance display when paper jamming has occurred in the printer unit during a copy reserving operation.

In this case, as in example 5, copy reservation frame 32 is displayed so as to be laid over, and shifted with respect to, printer status frame 31 with part of printer status frame 31 exposed to be seen, as shown in FIG. 11A. If a paper jam occurs in this state, window 34 indicating the content of the error is displayed preferentially at the approximate center of LCD 12 (in the frontmost layer viewed from the user), as shown in FIG. 11B. When ‘OK’ key 35 in this window 34 is touched by the user, controller 19 reads out the data of icon 33 in correspondence with window 34 from storage unit 16 and displays trouble icon 33 at the bottom left in printer status frame 31, as shown in FIG. 11C.

### EXAMPLE 8

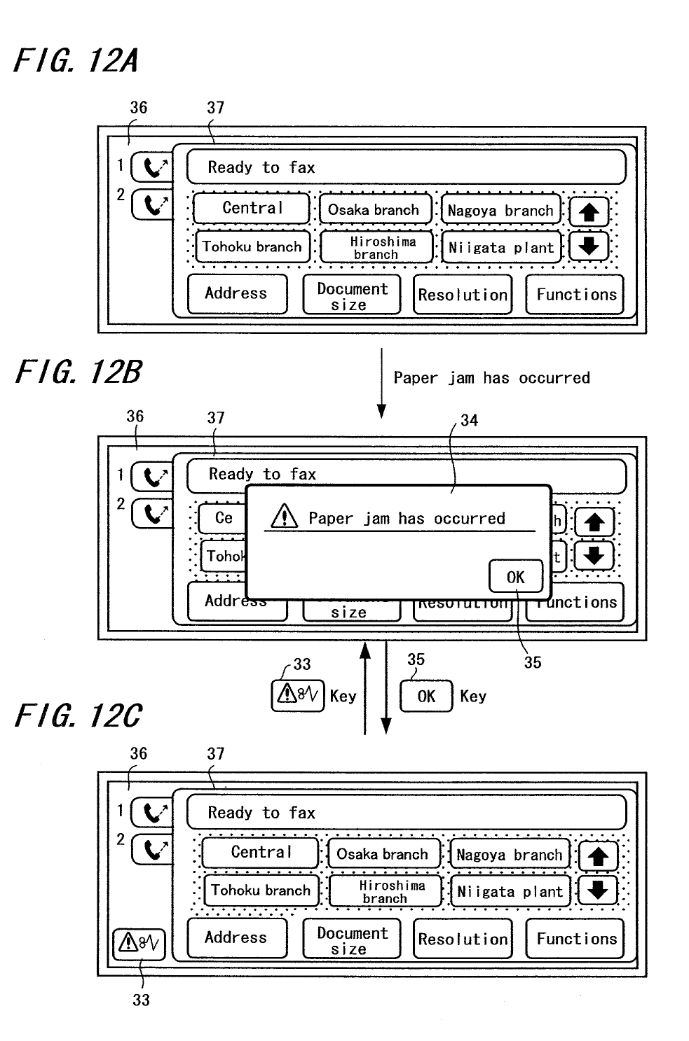

Also in example 8, the content of the error is displayed in warning window 34 similarly to example 3, thereafter icon 33 is displayed. FIGS. 12A to 12C are illustrative views of the example 8, showing the guidance display when paper jamming has occurred during a facsimile transmission.

In this case, as in example 6, facsimile transmission reservation frame 37 is displayed so as to be laid over, and shifted with respect to, facsimile transmission status frame 36 with part of facsimile transmission status frame 36 exposed to be seen, as shown in FIG. 12A. If a paper jam occurs in this display state in which facsimile reservation frame 37 is displayed preferentially in LCD 12, warning window 34 indicating the content of the error is displayed preferentially at the approximate center of LCD 12, as shown in FIG. 12B. When ‘OK’ key 35 in this warning window 34 is touched, trouble icon 33 is adapted to appear at the bottom left in facsimile transmission status frame 36, as shown in FIG. 12C.

Next, the operation of the guidance display process by controller 19 in examples 7 and 8 will be described with reference to the aforementioned flowchart shown in FIG. 8.

As shown in the figure, when an error (trouble) has occurred in printer unit 15, controller 19 displays the detailed guidance by warning window 34 preferentially in the frontmost layer at the approximate center of LCD 12 (S11). Thereafter, when ‘OK’ key 35 is touched by the user (S12), controller 19 displays icon 33 at the bottom left in window frame 31 or 36 of LCD 12 (S13). When the user touches this icon 33, the operation returns to the state where the detailed guidance information is displayed by warning display 34 (S15).

When ‘OK’ key 35 is not touched by the user (S12), it is checked at S16 whether the problem has been resolved by the user. Then, controller 19 removes trouble icon 33 from LCD 12 (S17) and completes the operation.

In this way, the warning window showing the detailed guidance information is displayed in the frontmost layer as soon as an error occurs, so that the user can obtain detailed information and take the necessary action. If the trouble is not one the user needs to resolve immediately, the user may display it in warning icon form in the exposed area of the job information window displayed in the background, so that other users are quickly able to know in which mode the error is occurring. The user is still prevented from being disturbed to implement their current operation.

### The Third Embodiment

The third embodiment is configured so that when an error has occurred, controller 19 determines whether the error is related to the job information window that is preferentially displayed on LCD 12 and selects the display form of the error. Examples 9 to 11 are the specific examples.

### EXAMPLE 9

Example 9 shows a case where a paper jam (sheet jam) error (trouble) has occurred while a user is making a copy reservation in digital multi-functional machine 10 and how the fact is displayed on LCD 12.

This display form will be described with reference to FIGS. 6A to 6C.

As shown in FIG. 6A, when a user makes a copy reservation in this multi-functional machine 10, copy reservation frame 32 is fully displayed (using substantially the full frame of the display) on LCD 12. When paper jamming has occurred in this mode, printing of a new copy reservation, if it is made, cannot be implemented efficiently. Controller 19 determines that this error correlates to the copy reservation task and will affect the job, and displays the information (detailed guidance information) indicating the content of the trouble on LCD 12 by using warning window 34, in a prominent manner, as shown in FIG. 6B.

Now, description will be made of how controller 19 determines the relationship between an error and an active job frame. First, correlations between job frames as job information windows and error warning information have been set up beforehand and stored in storage unit 16 (FIG. 1). Controller 19, as soon as a trouble has occurred in a functional unit such as scanner unit 14 or printer unit 15, determines whether the operation of the job frame being currently displayed has anything to do with the warning information of the trouble, based on the warning information of the trouble and correlation data read out from storage unit 16.

As shown in this figure, the display of the warning information in window form is displayed so as to be laid over at the approximate center of copy reservation frame 32 being displayed on LCD 12. When ‘OK’ key 35 arranged in this warning window display 34 is activated by the user, the condition of the apparatus is displayed as trouble icon 33, which is displayed at the bottom left of copy reservation frame 32 on LCD 12 at such a position that it does not affect the job information display including other windows, job information, keys and the like displayed on LCD 12, for example, it does not obstruct the job information display, and nor is it laid over the job information display (it is displayed at a non-overlaid position).

Further, when this trouble icon 33 is touched by the user, controller 19 displays the information (detailed guidance information) indicating the content of the trouble, once again, by warning window 34, at the approximate center of copy reservation frame 32 being displayed on LCD 12. In this way, it is possible to display and check the detailed guidance information of the trouble icon 33, at any time.

### EXAMPLE 10

Example 10 shows a case where a paper jam (sheet jam) error (trouble) has occurred while a user is performing a facsimile transmission in digital multi-functional machine 10 and how the fact is displayed on LCD 12.

This display form will be described with reference to FIGS. 4A to 4C.

As shown in FIG. 4A, when a user performs a facsimile transmission in this multi-functional machine 10, transmission reservation frame 37 is fully displayed (using substantially the full frame) on LCD 12. If paper jamming has occurred in the printer unit 15 in this mode, this will not directly affect the entry of a transmission reservation. Controller 19 determines that this error will not affect any facsimile transmission job, based on the correlation data stored in storage unit 16, and displays trouble icon 33 in a similar manner to the above at the bottom left of transmission reservation frame 37 being displayed on LCD 12, as shown in FIG. 4B. Further, when this trouble icon 33 is touched by the user, the content of the error is displayed by window 34, as shown in FIG. 4C. When ‘OK’ key 35 arranged in this warning window display 34 is touched, the display is adapted to return to the icon 33 representation shown in FIG. 4B.

### EXAMPLE 11

Similarly to example 9, example 11 shows a case where a paper jam (sheet jam) error (trouble) has occurred while a user is making a copy reservation in digital multi-functional machine 10 and how the fact is displayed on LCD 12.

This display form will be described with reference to FIGS. 11A to 11C.

As shown in FIG. 11A, in this multi-functional machine 10, copy reservation frame 32 is displayed on LCD 12 preferentially (on the front side viewed from the user) over printer status frame 31. More specifically, copy reservation frame 32 is laid over, and shifted with respect to, print status frame 31 with part of print status frame 31 exposed to be seen. In this display status, when paper jamming has occurred in printer unit 15, printing of anew copy reservation, if it is made, cannot be implemented efficiently. Controller 19 determines that this error correlates to the copy reservation task, and displays the information (detailed guidance information) indicating the content of the trouble, in a prominent manner over copy reservation frame (window) 32 being displayed on LCD 12, by using warning window 34, as shown in FIG. 11B.

As shown in this figure, the display of warning in window form is displayed so as to be laid over at the approximate center of copy reservation frame 32 being displayed on LCD 12. When ‘OK’ key 35 arranged in this warning window display 34 is activated by the user, warning information icon 33 related to printer unit 15 is displayed. More specifically, the condition of the apparatus is displayed concisely as trouble icon 33, which is displayed at the bottom left of printer status frame (window) 31 at such a position that it does not affect the job information display including other windows, job information, keys and the like displayed on LCD 12, for example, it does not obstruct the job information display or it is displayed at a non-overlaid and exposed area where it is not laid over the job information display.

In this way, since the current condition of the printer is displayed concisely in the printer status frame (window) 31 as the trouble icon 33 related to printer unit 15, it is possible for the user to know that there exists a problem to be taken care of in printer unit 15.

Further, when this trouble icon 33 is touched by the user, controller 19 is adapted to display the information (detailed guidance information) indicating the content of the trouble, once again, by warning window 34, at the approximate center of copy reservation frame (window) 32 being displayed on LCD 12. In this way, it is possible to display and check the detailed guidance information of the trouble icon 33, at any time.

### EXAMPLE 12

Similarly to example 10, example 12 shows a case where a paper jam (sheet jam) error (trouble) has occurred while a user is performing a facsimile transmission in digital multi-functional machine 10 and how the fact is displayed on LCD 12.

This display form will be described with reference to FIGS. 10A to 10C.

As shown in FIG. 10A, when a user performs a facsimile transmission in this multi-functional machine 10, facsimile transmission reservation frame 37 is displayed on LCD 12 preferentially (on the front side as viewed by the user) over facsimile transmission status frame 36. More specifically, facsimile transmission frame 37 is laid over, and shifted with respect to, facsimile transmission status frame 36 with part of facsimile transmission status frame 36 exposed to be seen. In this display status, if paper jamming has occurred in the printer unit 15, this will not directly affect the entry of a transmission reservation. Controller 19 determines that this error will not affect any facsimile transmission job, based on the correlation data stored in storage unit 16, and displays trouble icon 33 similar to the above at the bottom left of transmission reservation frame 37 being displayed on LCD 12, as in FIG. 10B. Further, when this trouble icon 33 is touched, the content of the error is displayed by window 34, as shown in FIG. 10C. When ‘OK’ key 35 in this warning window display 34 is touched, the display is adapted to return to the icon 33 representation shown in FIG. 10B.

In this way, in examples 9 to 12, controller 19 determines whether a trouble will affect the operation being displayed on LCD 12 and selects the icon or window display form.

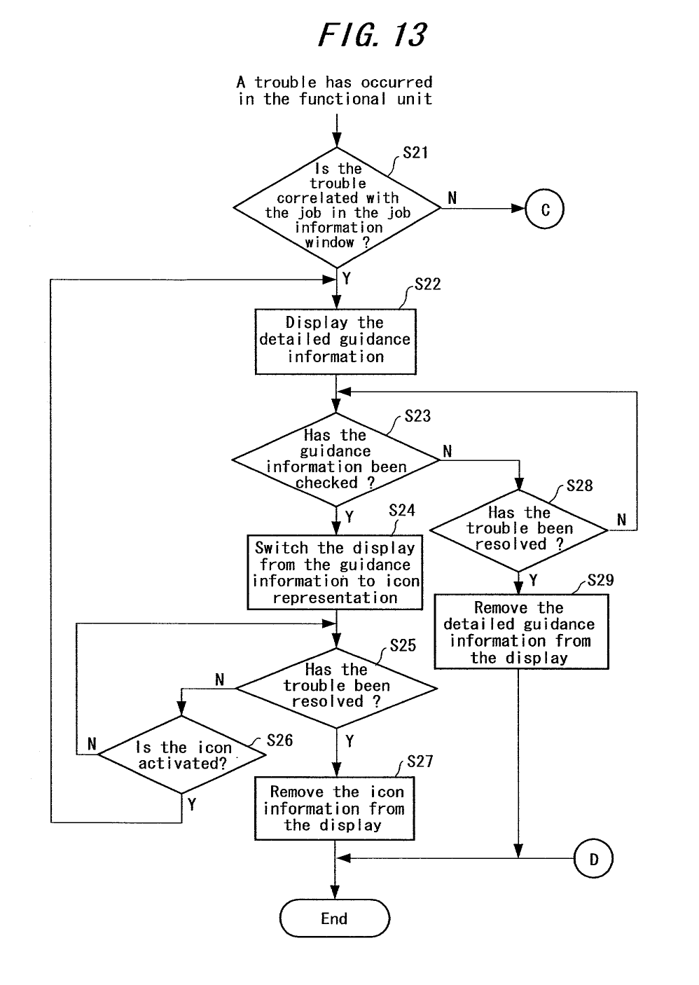

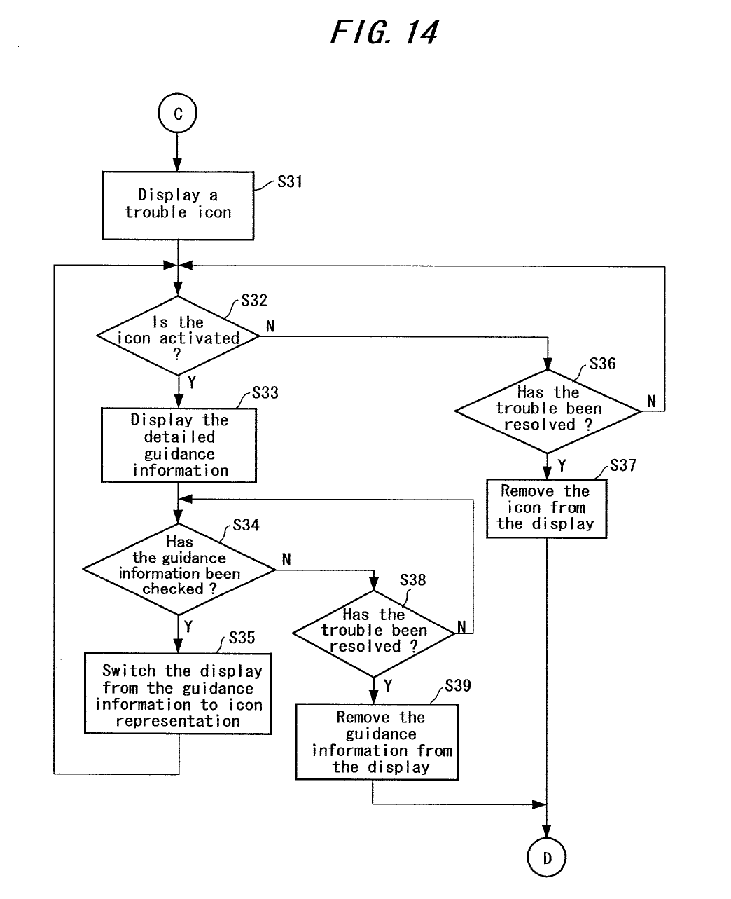

The display processing operation of controller 19 in the third embodiment (examples 9 to 12) will be described with reference to the flowcharts shown in FIGS. 13 and 14.

As shown in FIG. 13, for example, when an error (trouble) has occurred in printer unit 15, controller 19 determines whether the trouble will affect the process on the frame (job information window) being preferentially displayed on LCD 12. There are various types of job information windows, as shown in the above examples 9 to 12, such as that fully displayed (using substantially the full frame) as in examples 9 and 10, and that displayed so as to be laid over in the front layer as in examples 11 and 12. The data as to the correlations between job information windows and different problems has been stored in storage unit 16, and controller 19 makes a decision based on this data (S21). When a problem affects the process of the displayed operational window (examples 9 and 11), the detailed guidance of window 34 is displayed at the approximate center of LCD 12, preferentially in the frontmost layer thereof (S22). Then, when ‘OK’ key 35 is touched by the user (S23), controller 19 displays icon 33 at the bottom left of LCD 12 (S24). At this point, when the user touches this icon 33 (S25) with the problem unsolved (S25), the display goes back to the window representation of the detailed guidance information (S22).

On the other hand, when controller 19 confirms that the trouble has been resolved by the user (S25, S28), controller 19 removes window 34 having the detailed guidance information or trouble icon information 33 from LCD 12 (S26, S28) and completes the operation.

When the trouble is not one that affects the operation regarding to the display operational window (examples 10 and 12, FIG. 14), controller 19 displays small icon 33 at the bottom left of the display frame on LCD 12 (S31). Thereafter, when the user touches this trouble icon 33 (S32), controller 19 preferentially displays window 34 with the detailed guidance display at the center of LCD 12 (S33). Then, when ‘OK’ key 35 in the display of window 34 is touched by the user (S34), the display is returned so that small icon 33 is displayed once again at the bottom left of LCD 12 (S35).

On the other hand, when it is confirmed that the trouble has been resolved by the user (S36, 38), controller 19 removes trouble icon 33 or the guidance information by window 34 from LCD 12 (S37, S39) and completes the operation.

As described above, in multi-functional machine 10 of this embodiment (examples 9 to 12), once a trouble has occurred, controller 19 automatically selects the optimal display form for indicating the warning information, based on whether the warning information is correlated with the job of which the present user is making entry through the display. Explicitly, when there is a correlation, controller 19 displays the warning window at the center of the display frame on LCD 12; when there is no correlation, controller 19 displays the warning in icon form. In this way, once the problem has occurred, controller 19 determine the optimal display form of the warning information and displays it, therefore, the user is able to obtain detailed warning information of the trouble when it is needed for the user's job. When not needed for the job, the warning information can be switched into a form that will not cause any obstruction, or not hide the display required for the command control of a transmission reservation.

Further, display of the error information in icon representation is able to give a limited degree of warning to the user so that the error information to be displayed is not obtrusive. In this way, controller 19 automatically selects the optimal display form, so that it is possible to markedly improve the operativity.

Additionally, since the user is able to switch the display form of the warning information at desired timing without regard to the control of controller 19, this configuration provides high flexibility.

### The Fourth Embodiment

The fourth embodiment is configured so that when job control needs to be made to proceed during the occurrence of a trouble, the display form is selected based on whether the trouble affects the new job entry. Examples 13 to 16 are the specific examples.

### EXAMPLE 13

Example 13 shows the guidance display when a new entry of copy reservation is made by opening copy reservation frame 32 under conditions in which some trouble has occurred in printer unit 15 such as paper end in a paper feed tray. In this digital multi-functional machine 10 (FIG. 1), when a user inputs an entry of a copy job of new documents through control panel 11 under conditions in which an error(trouble) such as paper end has occurred in the printer unit, controller 19 is adapted to display warning guidance or a trouble icon for printer unit 15, at a predetermined area on LCD 12.

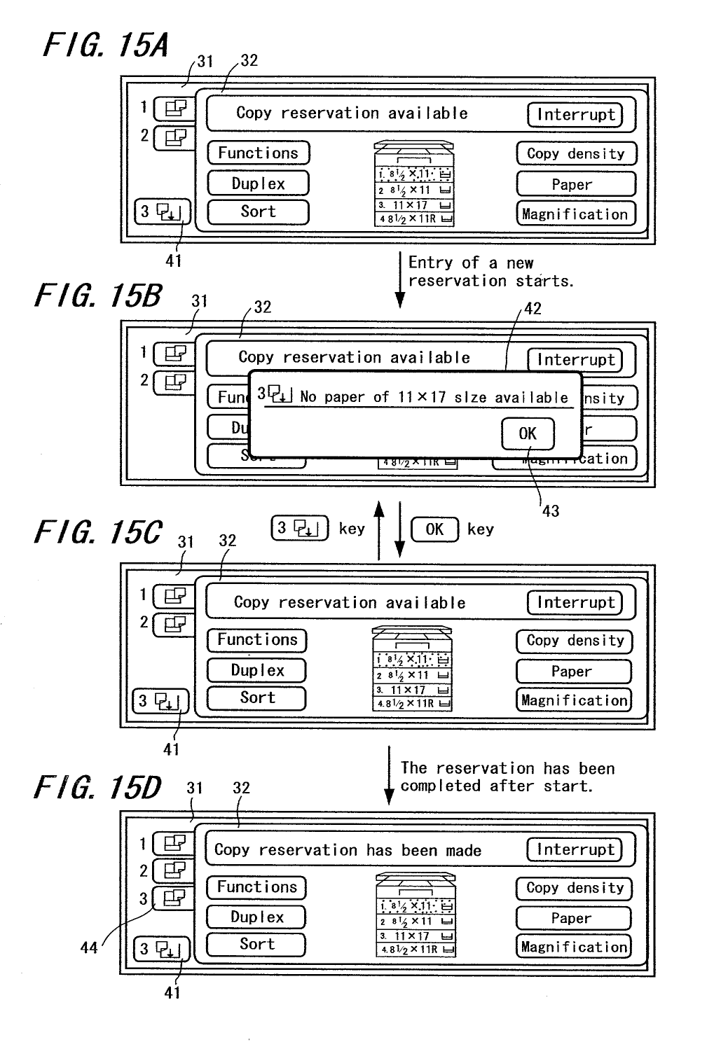

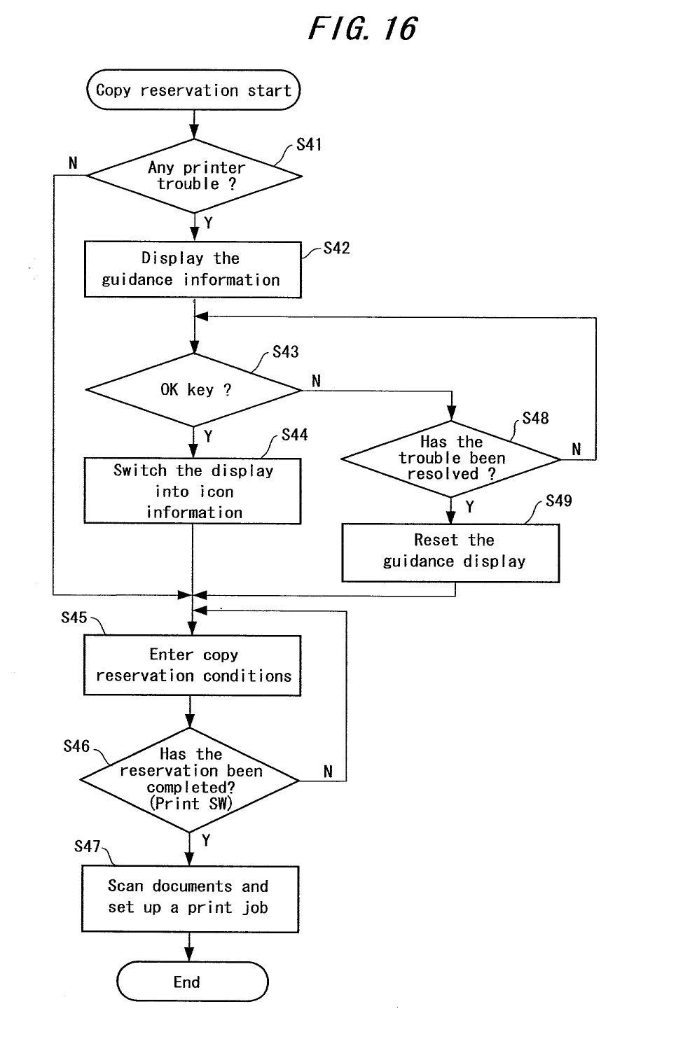

FIGS. 15A to 15D are illustrative views of example 13, showing the guidance display when entry of a new copy reservation is started under conditions where an error (paper end) has occurred in printer unit 15. FIG. 16 is a flowchart of the display processing sequence by the controller in example 13.

In multi-functional machine 10, it is assumed that first and second print jobs have been reserved and paper end has occurred in the third paper feed tray in printer unit 15. Therefore, the printer status frame is displayed on the display screen of LCD 12, where icons representing the first and second print jobs are displayed at the upper left and a trouble icon 41 indicating paper end is displayed at the bottom left.

Under this condition, it is assumed that a user starts to make a copy reservation. As shown in FIG. 15A, in multi-functional machine 10, the user may use frame select key 24 on control panel 11 so as to display copy reservation frame 32 on LCD 12, preferentially over printer status frame 31. That is, copy reservation frame 32 is displayed so as to be laid over, and shifted with respect to, printer status frame 31 with part of printer status frame 31 exposed to be seen. At this point, trouble icon 41 is displayed at the bottom left in the exposed area of printer status frame 31.

Next, the display operation of the warning information will be described.

Controller 19 checks whether the paper end indicated by trouble icon 41 will affect the copy job (S41). This is done based on the data which includes types of troubles affecting jobs and has been stored beforehand in storage unit 16. Paper end is determined to be adverse to performing effective printing when a new entry of copy reservation is made, so that the information (detailed guidance information) showing the content of the trouble is displayed at once on warning window 42 in a prominent manner, as shown in FIG. 15B (S42). Illustratively, as seen in this figure, the display of information by window 42 is adapted to be laid over at the approximate center of copy reservation frame 32 being displayed on LCD 12.

Then, when the user has grasped the status of printer unit 15 from the guidance information, and actuates ‘OK’ key 43 in this window 42 (S43). Then, the window disappears and trouble icon 41 indicating the condition of the machine appears instead, as shown in FIG. 15C, at the bottom left or other sites, of copy reservation frame 32 at such a position that it does not affect the job information display including other windows, job information, keys and the like, being displayed on LCD 12, for example, it does not obstruct the job information display, and nor is it laid over the job information display (is displayed at a non-overlaid position) (S44).

Though not shown in the flowchart of FIG. 16, when this trouble icon 41 is touched by the user, controller 19 once again displays the information indicating the content of the problem(detailed guidance information) by warning window 42, at the approximate center of copy reservation frame 32 being displayed on LCD 12, as shown in FIG. 15B. In this way, it is possible to display and check the detailed guidance information of trouble icon 41 at any time.

At this point, the user has confirmed the status of printer unit 15 (in this case, the fact that no paper exists in the third paper feed tray) and begins to input the conditions of a copy job reservation to reserve a copy job for new documents (S45). When the entry of the copy reservation completes (S46), scanner unit 14 scans the documents then an icon 44 as a new print job is added as the third print job, as shown in FIG. 15D (S47).

When the user has resolved the trouble after checking the guidance information (S48), the guidance display is reset (S49) hence no warning will be displayed.

### EXAMPLE 14

Example 14 shows the guidance display when a new reservation of a copy job using the third paper feed tray is entered by opening the copy reservation frame under conditions in which paper has run out in the third paper feed tray in the printer unit.

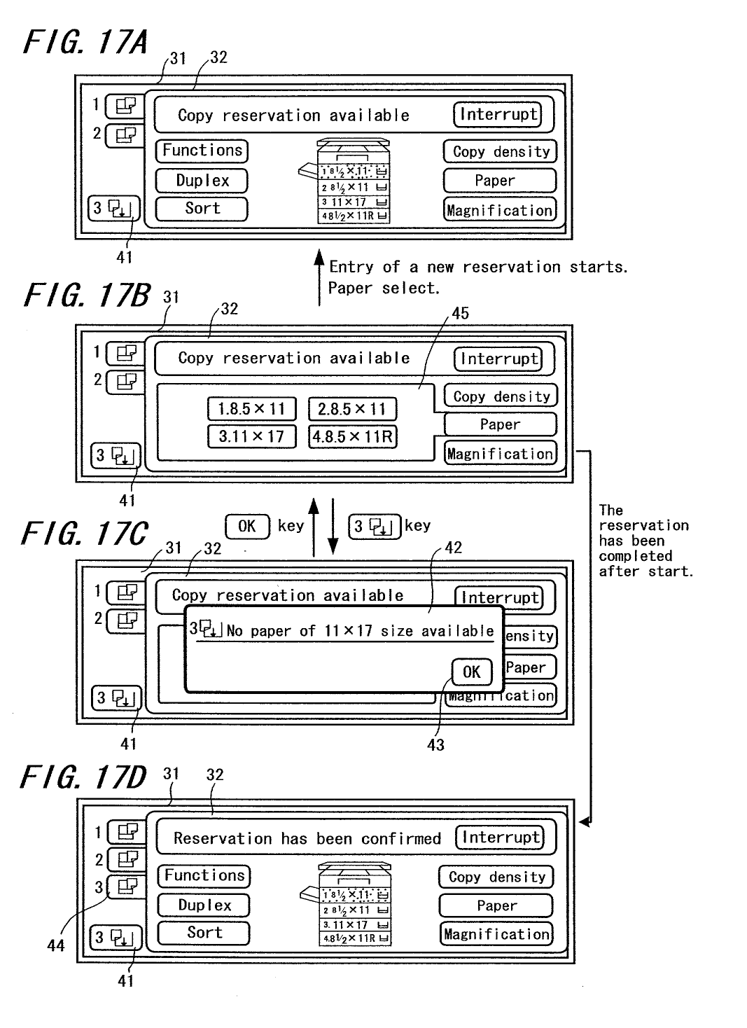

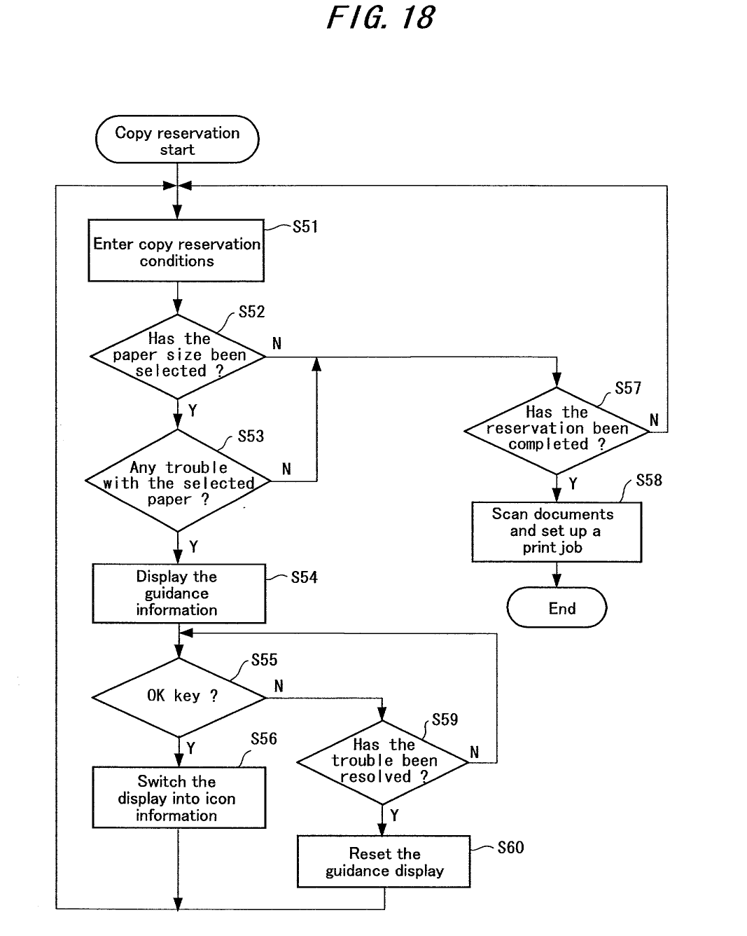

FIGS. 17A to 17D are illustrative views of example 14, showing the guidance display when entry of a new copy reservation is started under conditions where an error (paper end) has occurred in the printer unit. FIG. 18 is a flowchart of the display processing sequence by the controller in the example 14.

As shown in FIG. 17A, the display on LCD 12 when the user starts the copy reservation is the same as that in example 13. Next, the display operation of the trouble information will be described.

As shown in FIG. 17B, the user starts entry of copy reservation job conditions (S51) and opens a paper select frame 45 and selects the third paper feed tray, which has run out of paper, for the new copy reservation (S52).

At this point, controller 19 checks whether the paper end indicated by trouble icon 41 in printer status frame 31 will affect the copy job (S53). This print job using the selected paper is determined to be adverse to performing effective printing under the current situation, so that the information (detailed guidance information) showing the content of the trouble is displayed on LCD 12 at once by warning window 42 in a prominent manner, as shown in FIG. 17C (S54).

In the above description, the display is switched into the guidance display only after the third paper feed tray which has run out of paper is selected, but it is also possible to switch the display into that of the guidance so as to warn the user as soon as the paper select frame is opened or when the paper size automatically determined based on the original size and the copy magnification, coincides with that which has runs out.

As shown in FIG. 17C, the information from warning window 42 is displayed so as to be laid over at the approximate center of copy reservation frame 32 being displayed on LCD 12.

When the user has grasped the status of printer unit 15 from the guidance information and actuates ‘OK’ key 43 in this window (S55), the window disappears and trouble icon 41 indicating the condition of the machine appears instead, as shown in FIG. 17B, at the bottom left of the copy reservation frame at such a position that it does not affect the job information display including other windows, job information, keys and the like, displayed on LCD 12, for example, it does not obstruct the job information display, and nor is it laid over the job information display (is displayed at a non-overlaid position) (S56).

As mentioned in example 13, when this trouble icon 41 is touched by the user, controller 19 once again displays the information indicating the content of the trouble (detailed guidance information) by window 42, at the approximate center of the copy reservation frame being displayed on LCD 12 as shown in FIG. 17C. In this way, it is possible to display and check the detailed guidance information of trouble icon 41 at any time.

The user confirms the status of printer unit 15 (in this case, the fact that no paper exists in the third paper feed tray), and supplies the third paper feed tray with paper (S59) so as to reset the guidance display (S60).

On the other hand, when no selection of paper size is made (S52) or when the selection will not affect the copy job (S53), the entry of the copy reservation is advanced. When the copy reservation is completed (S57), the user causes the scanner unit 14 to scan the documents. Then icon 44 as a new print job is added as the third print job, as shown in FIG. 17D (S58). Thus, the print job of the new copy reservation can be processed smoothly.

### EXAMPLE 15

Example 15 shows the guidance display when a new entry of copy reservation using the staple finisher function is performed by opening the copy reservation frame under conditions in which a trouble has occurred, more explicitly, staples have run out in the staple finisher connected to the printer unit. In this digital multi-functional machine, an error (trouble) has occurred such as the supply of post-finisher for paper (such as staples) having run out in the post-processing apparatus (staple finisher, etc.) connected to the printer unit. When a user inputs through the control portion an entry of a copy job of new documents including post-processing of paper with images recorded, controller 19 is adapted to display warning guidance or a trouble icon of the trouble in the printer unit, at a predetermined area on LCD 12.

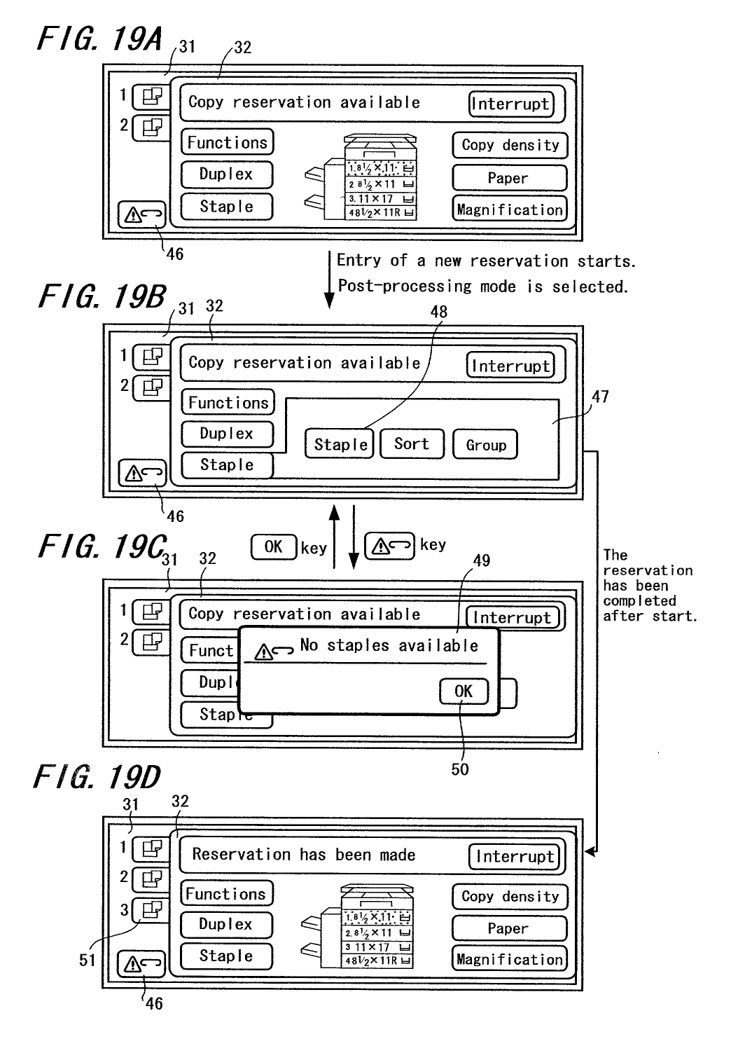

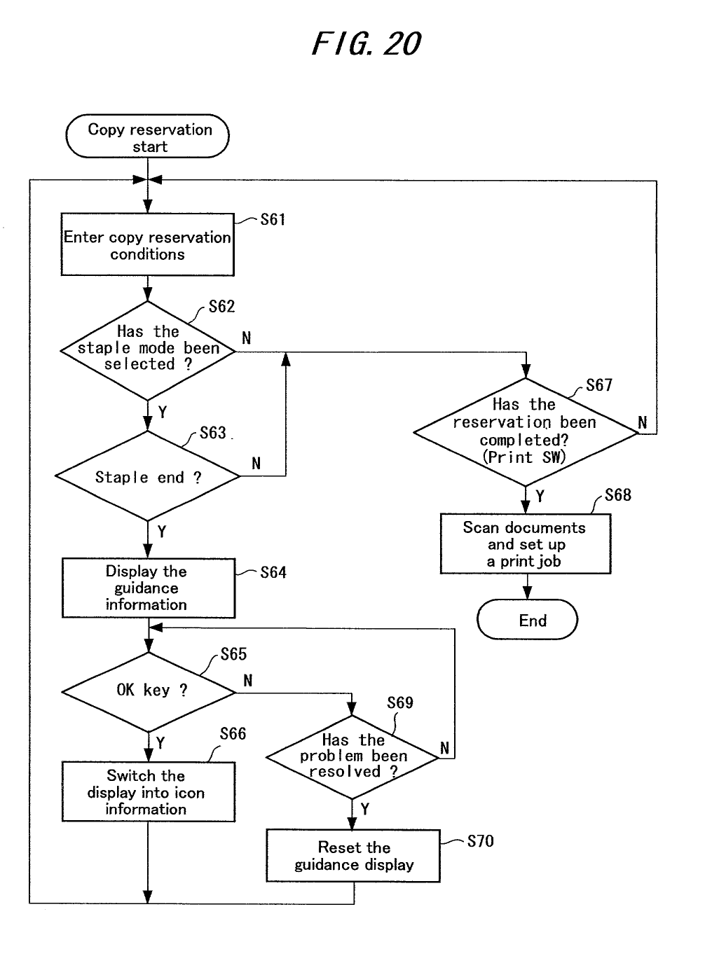

For example, FIGS. 19A to 19D are illustrative views of example 14, showing the guidance display when entry of a new copy reservation is started under conditions where an error (staple end) has occurred in printer unit 15. FIG. 20 is a flowchart of the display processing sequence by the controller in example 15.

In this multi-functional machine 10, it is assumed that first and second print jobs have been reserved and staple end has occurred in the paper post-processor (staple finisher). Therefore, printer status frame 31 is displayed on the display screen of LCD 12, where icons representing the first and second print jobs are displayed at the upper left and a trouble icon 46 indicating staple end is displayed at the bottom left.

Next, the display operation of the trouble information will be described.

Under this condition, it is assumed that a user starts to make a copy reservation. As shown in FIG. 19A, in this multi-functional machine 10, the user may use frame select key 24 on control panel 11 (FIG. 2) so as to display copy reservation frame 32 on LCD 12, preferentially over printer status frame 31. That is, copy reservation frame 32 is displayed so as to be laid over, and shifted with respect to, printer status frame 31 with part of printer status frame 31 exposed to be seen. At this point, trouble icon 46 is displayed in the exposed area of printer status frame 31.

As shown in FIG. 19B, the user starts to enter the copy reservation job conditions (S61), and opens a paper post-process setting frame 47 and selects the staple 48 function of which the staples have run out, for the new copy reservation (S62).

At this point, controller 19 checks whether the staple end indicated by trouble icon 46 in printer status frame 31 will affect the copy job (S63). In this case, the selected stapling for the paper is determined to be adverse to performing a smooth operation, so that the information (detailed guidance information) showing the content of the trouble is displayed on LCD 12 at once by warning window 49 in a prominent manner, as shown in FIG. 19C (S64).

In the above description, the display is switched into the guidance display only after staple function 48 is selected in paper post-processor setting frame 47, but it is also possible to switch the display into that of the guidance so as to warn the user as soon as paper post-processor setting frame 47 is opened.

As shown in the drawing, the information by warning window 49 is displayed so as to be laid over at the approximate center of copy reservation frame 32 being displayed on LCD 12. When having grasped the status of the paper post-processor from the guidance information, the user actuates ‘OK’ key 50 in this warning window 49 (S50). Then, the window disappears and trouble icon 46 indicating the condition of the machine appears instead, as shown in FIG. 19B, at the bottom left of copy reservation frame 32 at such a position that it does not affect the job information display including other windows, keys and the like, displayed on LCD 12, for example, it does not obstruct any display, and nor is it laid over the display (is displayed at a non-overlaid position) (S66).

When this trouble icon 46 is touched by the user, controller 19 once again displays the information indicating the content of the trouble (detailed guidance information) by window 49, at the approximate center of copy reservation frame 32 being displayed on LCD 12, as shown in FIG. 19C, whereby it is possible to display and check the detailed guidance information of trouble icon 46 at any time.

The user has confirmed the status of the paper post-processor (staple finisher) (in this case, the fact that no staples exist), and supplies the staple finisher with staples (S69) so as to reset the guidance display (S70).

On the other hand, when the job is not affected by stapling (S62) or when staples are not in shortage (S63), the entry of the copy reservation is advanced. When completing the copy reservation (S67) as shown in FIG. 19D, the user causes the scanner unit 14 to scan the documents. Then icon 51 as a new print job is added as the third print job (S68). Thus, the print job of the new copy reservation can be processed smoothly.

### EXAMPLE 16

Example 16 shows the guidance display when entry of a new transmission reservation is made by displaying the transmission reservation frame under conditions in which some problem has occurred in the printer unit.

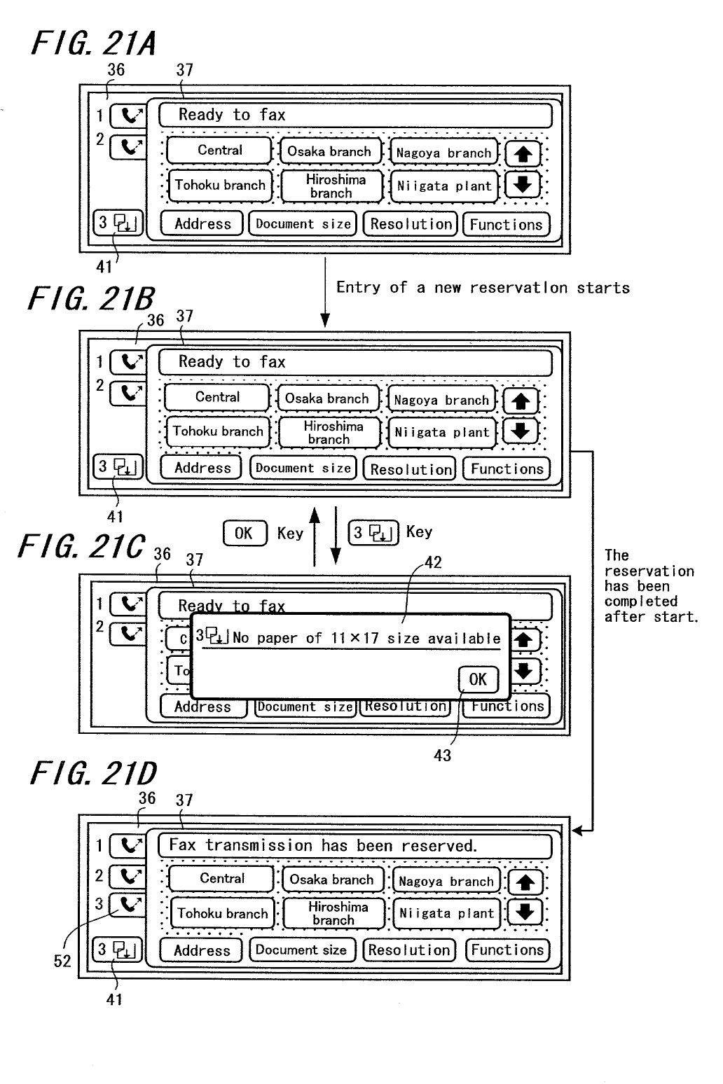

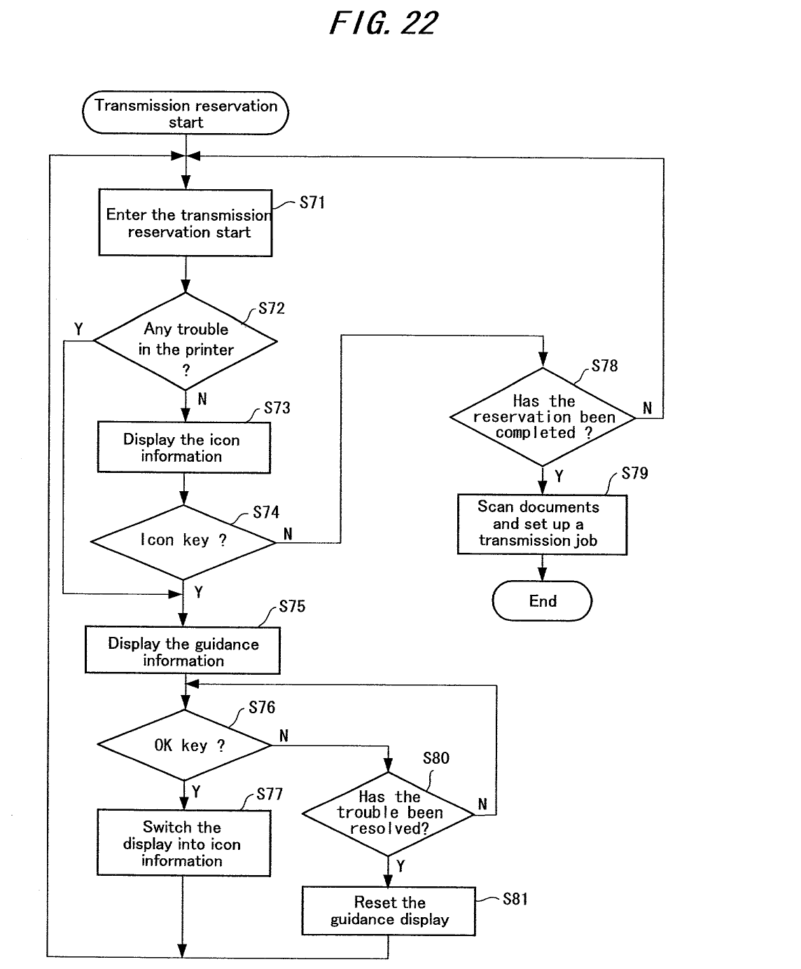

FIGS. 21A to 21D are illustrative views showing the trouble icon display or guidance display with respect to the print unit in the predetermined area on LCD 12, implemented by controller 19 when a new reservation of transmission job such as facsimile, email or the like is made under conditions where an error has occurred in printer unit 15. FIG. 22 is a flowchart of the display processing sequence by the controller in example 16.

In this multi-functional machine 10, it is assumed that first and second facsimile jobs have been reserved and paper end has occurred in the third paper feed tray in printer unit 15. Therefore, facsimile transmission status frame 36 is displayed on the display screen of LCD 12, where icons representing the first and second facsimile transmission jobs are displayed at the upper left and a trouble icon 41 indicating paper end is displayed at the bottom left.

Next, the display operation of the problem information will be described.

Under the condition of the above display, it is assumed that a user starts to make a facsimile transmission reservation. As shown in FIG. 21A, in this multi-functional machine 10, the user may use frame select key 24 on control panel 11 so as to display facsimile transmission reservation frame 37 on LCD 12, preferentially over facsimile transmission status frame 36. That is, facsimile transmission reservation frame 37 is displayed so as to be laid over, and shifted with respect to, facsimile transmission status frame 36 with part of facsimile transmission status frame 36 exposed to be seen. At this point, trouble icon 41 is displayed in the exposed area of facsimile transmission status frame 36.

As shown in FIG. 21B, when the user starts entry of copy reservation job conditions (S71), controller 19 checks whether the paper end indicated by trouble icon 41 on facsimile transmission status frame 36 will affect facsimile transmission (S72). This is done based on the data which includes types of troubles affecting jobs and has been stored beforehand in storage unit 16. Since the operation of transmission reservation frame 37 does not have any relationship with the output of imaging in printer unit 15 and the status of the printer unit, trouble icon 41 is displayed as is (S73). The entry is continued to complete the normal transmission reservation (S78), and scanner unit 14 scans the documents then an icon 52 as a new transmission job is added as the third item in the transmission job list, as shown in FIG. 21D (S79).

When the user touches trouble icon 41 in order to confirm the content of trouble icon 41 (S74), the guidance information is displayed by warning window 42 (S75). As shown in FIG. 21C, the information by warning window 42 is displayed so as to be laid over at the approximate center of the facsimile transmission reservation frame 37 being displayed on LCD 12.

When the user has grasped the status of printer unit 15 from the guidance information, and actuates ‘OK’ key 43 in this window (S76), the window disappears and trouble icon 41 indicating the condition of the machine appears instead, as shown in FIG. 21B, at the bottom left of facsimile transmission status frame 36 at such a position that it does not affect the job information display including other windows, keys and the like, being displayed on LCD 12, for example, it does not obstruct the display, and nor is it laid over the display (is displayed at a non-overlaid position) (S77).

When the user has resolved the trouble after checking the guidance information (S80), the guidance display is reset (S81) hence no warning will be displayed.

As described above, in multi-functional machine 10 of this embodiment (examples 13 to 16), when a new task (such as reservation entry of a copy job or transmission job) is advanced when some trouble has occurred, controller 19 automatically selects the optimal display form for indicating the warning information, based on whether the warning information is correlated with the new task. Explicitly, when there is a correlation, controller 19 displays the warning window at the center of the screen on LCD 12; when there is no correlation, controller 19 displays the warning in icon form. Therefore, this configuration does not trouble the user to select the optimal display frame, thus making it possible to markedly improve the operativity. Additionally, since the user is able to switch the display form of the warning information at the desired timing without regard to the control of controller 19, this configuration allows the user to select the display with high flexibility.

When warning information is displayed in icon form, it is possible to inform the user of there being a piece of error information to be displayed without hiding the display required for command control, hence it is possible to warn of the fact of a trouble having occurred without causing any obstruction to the user making a copy reservation.

Further, the present embodiments were described by taking error examples of paper having run out or staples having run out, and illustrations of the lacking of paper and the lacking of staples are used as the representations (patterns) of the icons. However, not limited to these, when an error other than above, such as toner empty, paper jamming, etc., has occurred in the multi-functional machine, the fact is adapted to be displayed in icon representation and window representation. In these cases, the pattern of the icon varies depending on the type of error.

Moreover, though, in the present embodiments, examples of the guidance display when an error has occurred in the printer unit were described, warnings in icon representation and in window representation can be provided similarly when an error has occurred in the scanner unit or communication unit.

Further, in the above examples, description was made as to the cases where two job information windows are displayed in an overlay manner, a greater number of windows may be displayed. In this case, at least one of the windows in the lower layers should have an exposed area allowing a warning icon to be displayed, so that the warning icon is displayed.

According to the present invention, since the controller displays a warning icon representing the warning information in the job information window without obstructing the job information display, it is possible to inform the user of there being a piece of error information to be displayed without hiding the display required for command control, hence it is possible to warn of the fact of a trouble having occurred without causing any obstruction to the user's control.

Further, according to the present invention, since in accordance with the user' instruction the warning window can be displayed instead of the warning icon in an overlaying manner over the job information window, it is possible to display the warning information by warning window at the user's desired timing. Therefore, the user is able to check the detailed content at any time.

Further, according to the present invention, since the controller gives information to the user by displaying the warning window including the display of warning information, in an overlaying manner over the job information window, the user is able to obtain the detailed information and take the necessary action.

According to another aspect of the present invention, in accordance with the user's instruction, since instead of its warning window a warning icon indicating warning information is displayed in the job information window without affecting the job information display, it is possible for the user to display the warning information in warning icon representation without obstructing the display of other display information if the trouble is not one the user needs to resolve immediately. In this way, it is possible to display the warning information in a form which does not disturb the current operation while giving warning to other users.

According to the present invention, when the warning information to be warned to the user has occurred or when there is a piece of warning information relating to a trouble having already occurred, the controller makes control such that when the warning information relates to the job of the currently displayed job information window, the warning window displaying the warning information is displayed so as to be laid over the job information window and when the warning information does not relate to the job of the currently displayed job information window, the warning information is displayed in warning icon representation so as not to affect the job information display in the job information window. Therefore, this configuration does not trouble the user to select the optimal display frame, thus making it possible to markedly improve the operativity.

Further, since the warning window is displayed in the frontmost layer and at the center of the display portion, this arrangement is able to attract the attention of the users and facilitates the user to check the content. Since the content of the process to be controlled by the user is displayed in the job information window which is displayed in the front layer, the user is able to obtain the warning information associated to that process and know the status of the apparatus required for making control. When the warning information is related to a trouble, the user is given it together with abase judgement as to whether the user should solve the trouble immediately or can advance the current task leaving it as is. As a result, the operativity can be improved.

1. An image processing apparatus which can implement a plurality of processing functions relating to imaging designated by a user, comprising:
an input portion through which a user inputs an instruction of a processing job relating to the processing functions;
a plurality types of functional units for implementing the processing functions relating to imaging;
a display portion for displaying information as to at least one processing function; and
a controller for controlling the input portion, functional units and display portion,
wherein when the display portion displays a job information window for displaying job information of the processing job, if there is warning information to be informed to the user, the controller displays a warning icon representing the warning information, at such a position in the job information window that the warning icon will not affect a display of the job information.

2. The image processing apparatus according to claim 1, wherein in accordance with the indication from the user through the input portion the controller is able to switch the display of the warning icon into a warning window displaying the warning information, in such a manner that the warning window is laid over the job information window.

3. The image processing apparatus according to claim 2, wherein the input portion is provided in the display portion.

4. The image processing apparatus according to claim 1, wherein the job information window is arranged in substantially a full frame of the display portion.

5. The image processing apparatus according to claim 2, wherein the warning window is displayed at an approximate center of the display portion.

6. The image processing apparatus according to claim 1, wherein the job information window displayed in the display portion is to display job information relating to the processing job for which the user inputs instructions through the input portion.

7. The image processing apparatus according to claim 1, wherein the warning information is trouble information as to the functional units.

8. An image processing apparatus which can implement a plurality of processing functions relating to imaging designated by a user, comprising:
an input portion through which a user inputs an instruction of a processing job relating to the processing functions;
a plurality types of functional units for implementing the processing functions relating to imaging;
a display portion for displaying information as to at least one processing function; and
a controller for controlling the input portion, functional units and display portion,
wherein when the display portion displays a job information window for displaying job information of the processing job, if there is warning information to be informed to the user, the controller displays a warning window displaying the warning information so as to be laid over the job information window.

9. The image processing apparatus according to claim 8, wherein in accordance with the indication from the user through the input portion the controller is able to switch the display of the warning window into a warning icon representing the warning information, displayed at such a position in the job information window that the warning icon will not affect the display of the job information.

10. The image processing apparatus according to claim 9, wherein the input portion is provided in the display portion.

11. The image processing apparatus according to claim 8, wherein the job information window is arranged in substantially a full frame of the display portion.

12. The image processing apparatus according to claim 8, wherein the warning window is displayed at an approximate center of the display portion.

13. The image processing apparatus according to claim 8, wherein the job information window displayed in the display portion is to display job information relating to the processing job for which the user inputs instructions through the input portion.

14. The image processing apparatus according to claim 8, wherein the warning information is trouble information as to the functional units.

15. An image processing apparatus which can implement a plurality of processing functions relating to imaging designated by a user, comprising:
an input portion through which a user inputs an instruction of a processing job relating to the processing functions;
a plurality types of functional units for implementing the processing functions relating to imaging;
a display portion for displaying information as to at least one processing function; and
a controller for controlling the input portion, functional units and display portion,
wherein the controller generates on the display portion a plurality of job information windows for displaying job information in accordance with processing jobs carried out by the functional units and displays the job information windows in an overlaid and shifted manner so that part of the job information window in a lower layer is exposed to be seen, and if there is warning information to be informed to the user, the controller displays a warning icon representing the warning information, at such a position in an exposed display portion of the job information window in the lower layer that the warning icon will not affect the display of the job information.

16. The image processing apparatus according to claim 15, wherein in accordance with the indication from the user through the input portion the controller is able to switch the display of the warning icon into a warning window displaying the warning information, in such a manner that the warning window is laid over the job information window in a front layer.

17. The image processing apparatus according to claim 16, wherein the input portion is provided in the display portion.

18. The image processing apparatus according to claim 15, wherein the warning window is displayed at an approximate center of the display portion.

19. The image processing apparatus according to claim 15, wherein the job information window displayed in a front layer of the display portion is to display job information relating to the processing job for which the user inputs instructions through the input portion.

20. The image processing apparatus according to claim 15, wherein the warning information is trouble information as to the functional units.

21. An image processing apparatus which can implement a plurality of processing functions relating to imaging designated by a user, comprising:
an input portion through which a user inputs an instruction of a processing job relating to the processing functions;
a plurality types of functional units for implementing the processing functions relating to imaging;
a display portion for displaying information as to at least one processing function; and
a controller for controlling the input portion, functional units and display portion,
wherein the controller generates on the display portion a plurality of job information windows for displaying job information in accordance with processing jobs carried out by the functional units and displays the job information windows in an overlaid and shifted manner so that part of the job information window in a lower layer is exposed to be seen, and if there is warning information to be informed to the user, the controller displays a warning window displaying warning information so as to be laid over the job information window in a front layer.

22. The image processing apparatus according to claim 21, wherein in accordance with the indication from the user through the input portion the controller switches the display of the warning window into a warning icon representing the warning information, displayed at such a position in an exposed display portion of the job information window in the lower layer that the warning icon will not affect the display of the job information.

23. The image processing apparatus according to claim 22, wherein the input portion is provided in the display portion.

24. The image processing apparatus according to claim 21, wherein the warning window is displayed at an approximate center of the display portion.

25. The image processing apparatus according to claim 21, wherein the job information window displayed in a front layer of the display portion is to display job information relating to the processing job for which the user inputs instructions through the input portion.

26. The image processing apparatus according to claim 21, wherein the warning information is trouble information as to the functional units.

27. An image processing apparatus which can implement a plurality of processing functions relating to imaging designated by a user, comprising:
an input portion through which a user inputs an instruction of a processing job relating to the processing functions;
a plurality types of functional units for implementing the processing functions relating to imaging;
a display portion for displaying information as to at least one processing function; and
a controller for controlling the input portion, functional units and display portion,
wherein the controller generates a job information window for displaying job information for each processing job carried out by the functional units and displays the job information window on the display portion, and when warning information to be informed to the user has occurred and if the warning information relates to a job content in the job information window, the controller displays a warning window displaying the warning information so as to be laid over the job information window; when warning information to be informed to the user has occurred and if the warning information does not relate to a job content in the job information window, the controller displays a warning icon representing the warning information at such a position in the job information window that the warning icon will not affect a display of the job information.

28. The image processing apparatus according to claim 27, wherein the warning window is displayed at an approximate center of the display portion.

29. The image processing apparatus according to claim 27, wherein the job information window displayed in the display portion is to display job information relating to the processing job for which the user inputs instructions through the input portion.

30. The image processing apparatus according to claim 27, wherein the warning information is trouble information as to the functional units.

31. The image processing apparatus according to claim 27, wherein when a new processing job is entered and if the new job relates to the warning information the controller displays a warning window so as to be laid over the job information window; and if the new job does not relate to the job content in the job information window the controller displays a warning icon at such a position in the job information window that the warning icon will not affect the display of the job information.

32. An image processing apparatus which can implement a plurality of processing functions relating to imaging designated by a user, comprising:
an input portion through which a user inputs an instruction of a processing job relating to the processing functions;
a plurality types of functional units for implementing the processing functions relating to imaging;
a display portion for displaying information as to at least one processing function; and
a controller for controlling the input portion, functional units and display portion,
wherein the controller generates one job information window for displaying job information for each type of processing jobs carried out by the functional units and displays the job information windows in an overlaid and shifted manner so that part of the job information windows in a lower layer is exposed to be seen, and when any of the functions has warning information to be informed to the user and if the warning information relates to a job content of the job information window being displayed in a frontmost layer, the controller displays a warning window displaying the warning information so as to be laid over the job information window in the frontmost layer; when any of the functions has warning information to be informed to the user and if the warning information does not relate to a job content of the job information window being displayed in a frontmost layer, the controller displays a warning icon representing the warning information at such a position in a exposed display portion of the job information window in the lower layer that the icon will not affect a display of the job information in the lower layer.

33. The image processing apparatus according to claim 32, wherein the warning window is displayed at an approximate center of the display portion.

34. The image processing apparatus according to claim 32, wherein the job information window displayed in a front layer of the display portion is to display job information relating to the processing job for which the user inputs instructions through the input portion.

35. The image processing apparatus according to claim 32, wherein the warning information is trouble information as to the functional units.

36. The image processing apparatus according to claim 32, wherein when a new job is entered, the controller displays a warning window so as to be laid over the job information window when the new processing job relates to the warning information; and the controller displays a warning icon at such a position in the job information window that the icon will not affect the display of the job information when the new job does not relate to the job content of the job information window.
